(19) United States
(12) Patent Application Publication
(10) Pub. No.: US 2024/0063978 A1
(43) Pub. Date: Feb. 22, 2024

(54) SYSTEM AND METHOD FOR EFFICIENT UTILIZATION OF PADDING BITS

(71) Applicant: Toyota Jidosha Kabushiki Kaisha, Aichi-ken (JP)

(72) Inventor: Andreas Falkenberg, Escondido, CA (US)

(21) Appl. No.: 17/448,480

(22) Filed: Sep. 22, 2021

Related U.S. Application Data
(60) Provisional application No. 63/081,641, filed on Sep. 22, 2020.

(51) Int. Cl. H04L 5/00; H04W 72/04

(52) U.S. Cl. CPC H04L 5/0053; H04W 72/042; H04L 5/008

(57) ABSTRACT

A system, method and apparatus for mobile communications is provided. A computing device determines determining whether to append padding bits to a sequence of downlink control information (DCI) bits. The individual bits in the sequence of DCI bits are associated with an importance factor. Responsive to a determination to append padding bits, the computing device selects from the sequence of DCI bits, a number of bits as the padding bits based at least in part on the importance factors of the individual bits in the sequence of DCI bits. The computing device appends the selected padding bits to the sequence of DCI bits.

### CROSS-REFERENCE TO RELATED APPLICATION

This application claims the benefit of U.S. Provisional Application No. 63/081,641, entitled SYSTEM AND METHOD FOR EFFICIENT UTILIZATION OF PADDING BITS, and filed on Sep. 22, 2020. U.S. Provisional Application No. 63/081,641 is incorporated by reference herein.

### BACKGROUND

Generally described, computing devices and communication networks can be utilized to exchange information. In a common application, a computing device can request/transmit data with another computing device via the communication network. More specifically, computing devices may utilize a wireless communication network to exchange information or establish communication channels.

Wireless communication networks can include a wide variety of devices that include or access components to access a wireless communication network. Such devices can utilize the wireless communication network to facilitate interactions with other devices that can access the wireless communication network or to facilitate interaction, through the wireless communication network, with devices utilizing other communication networks.

### BRIEF DESCRIPTION OF THE DRAWINGS

FIG. 1 shows an example of a system of mobile communications according to some aspects of some of various exemplary embodiments of the present disclosure.

FIG. 2A and FIG. 2B show examples of radio protocol stacks for user plane and control plane, respectively, according to some aspects of some of various exemplary embodiments of the present disclosure.

FIG. 3A, FIG. 3B and FIG. 3C show example mappings between logical channels and transport channels in downlink, uplink and sidelink, respectively, according to some aspects of some of various exemplary embodiments of the present disclosure.

FIG. 4A, FIG. 4B and FIG. 4C show example mappings between transport channels and physical channels in downlink, uplink and sidelink, respectively, according to some aspects of some of various exemplary embodiments of the present disclosure.

FIG. 5A, FIG. 5B, FIG. 5C and FIG. 5D show examples of radio protocol stacks for NR sidelink communication according to some aspects of some of various exemplary embodiments of the present disclosure.

FIG. 6 shows example physical signals in downlink, uplink and sidelink according to some aspects of some of various exemplary embodiments of the present disclosure.

FIG. 7 shows examples of Radio Resource Control (RRC) states and transitioning between different RRC states according to some aspects of some of various exemplary embodiments of the present disclosure.

FIG. 8 shows example frame structure and physical resources according to some aspects of some of various exemplary embodiments of the present disclosure.

FIG. 9 shows example component carrier configurations in different carrier aggregation scenarios according to some aspects of some of various exemplary embodiments of the present disclosure.

FIG. 10 shows example bandwidth part configuration and switching according to some aspects of some of various exemplary embodiments of the present disclosure.

FIG. 11 shows example four-step contention-based and contention-free random access processes according to some aspects of some of various exemplary embodiments of the present disclosure.

FIG. 12 shows example two-step contention-based and contention-free random access processes according to some aspects of some of various exemplary embodiments of the present disclosure.

FIG. 13 shows example time and frequency structure of Synchronization Signal and Physical Broadcast Channel (PBCH) Block (SSB) according to some aspects of some of various exemplary embodiments of the present disclosure.

FIG. 14 shows example SSB burst transmissions according to some aspects of some of various exemplary embodiments of the present disclosure.

FIG. 15 shows example components of a user equipment and a base station for transmission and/or reception according to some aspects of some of various exemplary embodiments of the present disclosure.

FIG. 16 shows an example convolutional encoder structure according to some aspects of some of various exemplary embodiments of the present disclosure.

FIG. 17 shows example DCI formats according to some aspects of some of various exemplary embodiments of the present disclosure.

FIG. 18 shows an example process according to some aspects of some of various exemplary embodiments of the present disclosure.

FIG. 19 shows an example process according to some aspects of some of various exemplary embodiments of the present disclosure.

FIG. 20 shows an example process according to some aspects of some of various exemplary embodiments of the present disclosure.

FIG. 21 shows an example process according to some aspects of some of various exemplary embodiments of the present disclosure.

FIG. 22 shows an example process according to some aspects of some of various exemplary embodiments of the present disclosure.

FIG. 23 shows an example process according to some aspects of some of various exemplary embodiments of the present disclosure.

FIG. 24 shows an example process according to some aspects of some of various exemplary embodiments of the present disclosure.

FIG. 25 shows an example process according to some aspects of some of various exemplary embodiments of the present disclosure.

FIG. 26 shows an example process according to some aspects of some of various exemplary embodiments of the present disclosure.

FIG. 27 shows an example process according to some aspects of some of various exemplary embodiments of the present disclosure.

### DETAILED DESCRIPTION

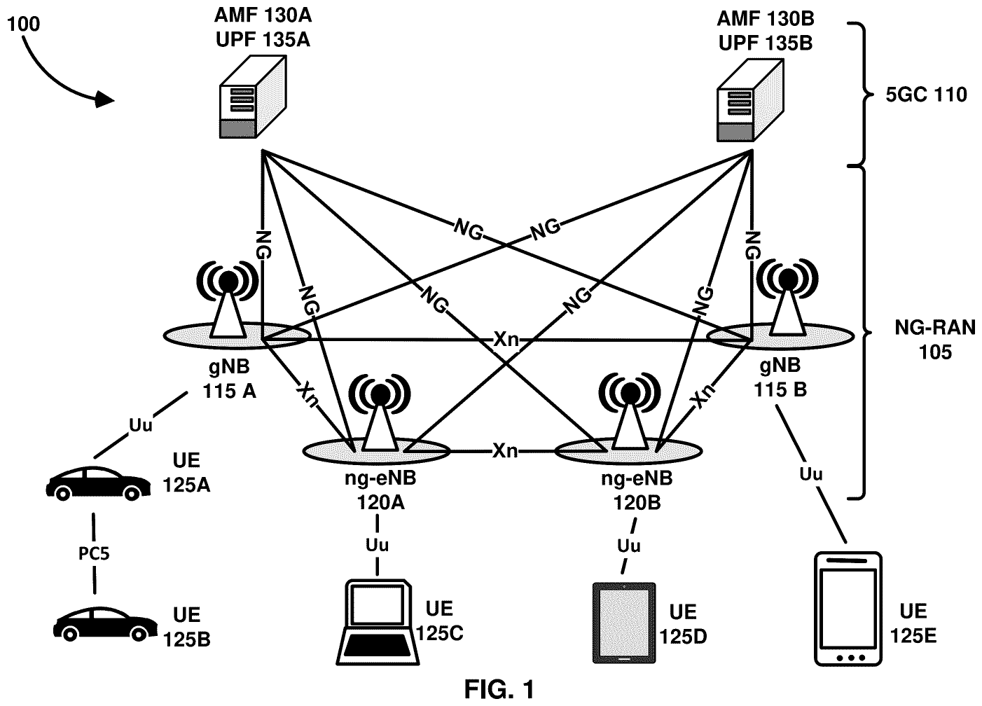

FIG. 1 shows an example of a system of mobile communications 100 according to some aspects of some of various exemplary embodiments of the present disclosure. The system of mobile communication 100 may be operated by a wireless communications system operator such as a Mobile Network Operator (MNO), a private network operator, a Multiple System Operator (MSO), an Internet of Things (JOT) network operator, etc., and may offer services such as voice, data (e.g., wireless Internet access), messaging, vehicular communications services such as Vehicle to Everything (V2X) communications services, safety services, mission critical service, services in residential, commercial or industrial settings such as IoT, industrial IOT (HOT), etc.

The system of mobile communications 100 may enable various types of applications with different requirements in terms of latency, reliability, throughput, etc. Example supported applications include enhanced Mobile Broadband (eMBB), Ultra-Reliable Low-Latency Communications (URLLC), and massive Machine Type Communications (mMTC). eMBB may support stable connections with high peak data rates, as well as moderate rates for cell-edge users. URLLC may support application with strict requirements in terms of latency and reliability and moderate requirements in terms of data rate. Example mMTC application includes a network of a massive number of IoT devices, which are only sporadically active and send small data payloads.

The system of mobile communications 100 may include a Radio Access Network (RAN) portion and a core network portion. The example shown in FIG. 1 illustrates a Next Generation RAN (NG-RAN) 105 and a 5G Core Network (5GC) 110 as examples of the RAN and core network, respectively. Other examples of RAN and core network may be implemented without departing from the scope of this disclosure. Other examples of RAN include Evolved Universal Terrestrial Radio Access Network (EUTRAN), Universal Terrestrial Radio Access Network (UTRAN), etc. Other examples of core network include Evolved Packet Core (EPC), UMTS Core Network (UCN), etc. The RAN implements a Radio Access Technology (RAT) and resides between User Equipments (UEs) 125 and the core network. Examples of such RATs include New Radio (NR), Long Term Evolution (LTE) also known as Evolved Universal Terrestrial Radio Access (EUTRA), Universal Mobile Telecommunication System (UMTS), etc. The RAT of the example system of mobile communications 100 may be NR. The core network resides between the RAN and one or more external networks (e.g., data networks) and is responsible for functions such as mobility management, authentication, session management, setting up bearers and application of different Quality of Services (QoSs). The functional layer between the UE 125 and the RAN (e.g., the NG-RAN 105) may be referred to as Access Stratum (AS) and the functional layer between the UE 125 and the core network (e.g., the 5GC 110) may be referred to as Non-access Stratum (NAS).

The UEs 125 may include wireless transmission and reception means for communications with one or more nodes in the RAN, one or more relay nodes, or one or more other UEs, etc. Example of UEs include, but are not limited to, smartphones, tablets, laptops, computers, wireless transmission and/or reception units in a vehicle, V2X or Vehicle to Vehicle (V2V) devices, wireless sensors, IoT devices, IIOT devices, etc. Other names may be used for UEs such as a Mobile Station (MS), terminal equipment, terminal node, client device, mobile device, etc. Still further, UEs 125 may also include components or subcomponents integrated into other devices, such as vehicles, to provide wireless communication functionality with nodes in the RAN as described herein. Such other devices may have other functionality or multiple functionalities in addition to wireless communications.

The RAN may include nodes (e.g., base stations) for communications with the UEs. For example, the NG-RAN 105 of the system of mobile communications 100 may comprise nodes for communications with the UEs 125. Different names for the RAN nodes may be used, for example depending on the RAT used for the RAN. A RAN node may be referred to as Node B (NB) in a RAN that uses the UMTS RAT. A RAN node may be referred to as an evolved Node B (eNB) in a RAN that uses LTE/EUTRA RAT. For the illustrative example of the system of mobile communications 100 in FIG. 1, the nodes of an NG-RAN 105 may be either a next generation Node B (gNB) 115 or a next generation evolved Node B (ng-eNB) 120. In this specification, the terms base station, RAN node, gNB and ng-eNB may be used interchangeably. The gNB 115 may provide NR user plane and control plane protocol terminations towards the UE 125. The ng-eNB 120 may provide E-UTRA user plane and control plane protocol terminations towards the UE 125. An interface between the gNB 115 and the UE 125 or between the ng-eNB 120 and the UE 125 may be referred to as a Uu interface. The Uu interface may be established with a user plane protocol stack and a control plane protocol stack. For a Uu interface, the direction from the base station (e.g., the gNB 115 or the ng-eNB 120) to the UE 125 may be referred to as downlink and the direction from the UE 125 to the base station (e.g., gNB 115 or ng-eNB 120) may be referred to as uplink.

The gNBs 115 and ng-eNBs 120 may be interconnected with each other by means of an Xn interface. The Xn interface may comprise an Xn User plane (Xn-U) interface and an Xn Control plane (Xn-C) interface. The transport network layer of the Xn-U interface may be built on Internet Protocol (IP) transport and GPRS Tunneling Protocol (GTP) may be used on top of User Datagram Protocol (UDP)/IP to carry the user plane protocol data units (PDUs). Xn-U may provide non-guaranteed delivery of user plane PDUs and may support data forwarding and flow control. The transport network layer of the Xn-C interface may be built on Stream Control Transport Protocol (SCTP) on top of IP. The application layer signaling protocol may be referred to as XnAP (Xn Application Protocol). The SCTP layer may provide the guaranteed delivery of application layer messages. In the transport IP layer, point-to-point transmission may be used to deliver the signaling PDUs. The Xn-C interface may support Xn interface management, UE mobility management, including context transfer and RAN paging, and dual connectivity.

The gNBs 115 and ng-eNBs 120 may also be connected to the 5GC 110 by means of the NG interfaces, more specifically to an Access and Mobility Management Function (AMF) 130 of the 5GC 110 by means of the NG-C interface and to a User Plane Function (UPF) 135 of the 5GC 110 by means of the NG-U interface. The transport network layer of the NG-U interface may be built on IP transport and GTP protocol may be used on top of UDP/IP to carry the user plane PDUs between the NG-RAN node (e.g., gNB 115 or ng-eNB 120) and the UPF 135. NG-U may provide non-guaranteed delivery of user plane PDUs between the NG-RAN node and the UPF. The transport network layer of the NG-C interface may be built on IP transport. For the reliable transport of signaling messages, SCTP may be added on top of IP. The application layer signaling protocol may be referred to as NGAP (NG Application Protocol). The SCTP layer may provide guaranteed delivery of application layer messages. In the transport, IP layer point-to-point transmission may be used to deliver the signaling PDUs. The NG-C interface may provide the following functions: NG interface management; UE context management; UE mobility management; transport of NAS messages; paging; PDU Session Management; configuration transfer; and warning message transmission.

The gNB 115 or the ng-eNB 120 may host one or more of the following functions: Radio Resource Management functions such as Radio Bearer Control, Radio Admission Control, Connection Mobility Control, Dynamic allocation of resources to UEs in both uplink and downlink (e.g., scheduling); IP and Ethernet header compression, encryption and integrity protection of data; Selection of an AMF at UE attachment when no routing to an AMF can be determined from the information provided by the UE; Routing of User Plane data towards UPF(s); Routing of Control Plane information towards AMF; Connection setup and release; Scheduling and transmission of paging messages; Scheduling and transmission of system broadcast information (e.g., originated from the AMF); Measurement and measurement reporting configuration for mobility and scheduling; Transport level packet marking in the uplink; Session Management; Support of Network Slicing; QoS Flow management and mapping to data radio bearers; Support of UEs in RRC Inactive state; Distribution function for NAS messages; Radio access network sharing; Dual Connectivity; Tight interworking between NR and E-UTRA; and Maintaining security and radio configuration for User Plane 5G system (5GS) Cellular IoT (CIoT) Optimization.

The AMF 130 may host one or more of the following functions: NAS signaling termination; NAS signaling security; AS Security control; Inter CN node signaling for mobility between 3GPP access networks; Idle mode UE Reachability (including control and execution of paging retransmission); Registration Area management; Support of intra-system and inter-system mobility; Access Authentication; Access Authorization including check of roaming rights; Mobility management control (subscription and policies); Support of Network Slicing; Session Management Function (SMF) selection; Selection of 5GS CIoT optimizations.

The UPF 135 may host one or more of the following functions: Anchor point for Intra-/Inter-RAT mobility (when applicable); External PDU session point of interconnect to Data Network; Packet routing 86 forwarding; Packet inspection and User plane part of Policy rule enforcement; Traffic usage reporting; Uplink classifier to support routing traffic flows to a data network; Branching point to support multi-homed PDU session; QoS handling for user plane, e.g. packet filtering, gating, UL/DL rate enforcement; Uplink Traffic verification (Service Data Flow (SDF) to QoS flow mapping); Downlink packet buffering and downlink data notification triggering.

As shown in FIG. 1, the NG-RAN 105 may support the PC5 interface between two UEs 125 (e.g., UE 125A and UE125B). In the PC5 interface, the direction of communications between two UEs (e.g., from UE 125A to UE 125B or vice versa) may be referred to as sidelink. Sidelink transmission and reception over the PC5 interface may be supported when the UE 125 is inside NG-RAN 105 coverage, irrespective of which RRC state the UE is in, and when the UE 125 is outside NG-RAN 105 coverage. Support of V2X services via the PC5 interface may be provided by NR sidelink communication and/or V2X sidelink communication.

PC5-S signaling may be used for unicast link establishment with Direct Communication Request/Accept message. A UE may self-assign its source Layer-2 ID for the PC5 unicast link for example based on the V2X service type. During unicast link establishment procedure, the UE may send its source Layer-2 ID for the PC5 unicast link to the peer UE, e.g., the UE for which a destination ID has been received from the upper layers. A pair of source Layer-2 ID and destination Layer-2 ID may uniquely identify a unicast link. The receiving UE may verify that the said destination ID belongs to it and may accept the Unicast link establishment request from the source UE. During the PC5 unicast link establishment procedure, a PC5-RRC procedure on the Access Stratum may be invoked for the purpose of UE sidelink context establishment as well as for AS layer configurations, capability exchange etc. PC5-RRC signaling may enable exchanging UE capabilities and AS layer configurations such as Sidelink Radio Bearer configurations between pair of UEs for which a PC5 unicast link is established.

NR sidelink communication may support one of three types of transmission modes (e.g., Unicast transmission, Groupcast transmission, and Broadcast transmission) for a pair of a Source Layer-2 ID and a Destination Layer-2 ID in the AS. The Unicast transmission mode may be characterized by: Support of one PC5-RRC connection between peer UEs for the pair; Transmission and reception of control information and user traffic between peer UEs in sidelink; Support of sidelink HARQ feedback; Support of sidelink transmit power control; Support of RLC Acknowledged Mode (AM); and Detection of radio link failure for the PC5-RRC connection. The Groupcast transmission may be characterized by: Transmission and reception of user traffic among UEs belonging to a group in sidelink; and Support of sidelink HARQ feedback. The Broadcast transmission may be characterized by: Transmission and reception of user traffic among UEs in sidelink.

A Source Layer-2 ID, a Destination Layer-2 ID and a PC5 Link Identifier may be used for NR sidelink communication. The Source Layer-2 ID may be a link-layer identity that identifies a device or a group of devices that are recipients of sidelink communication frames. The Destination Layer-2 ID may be a link-layer identity that identifies a device that originates sidelink communication frames. In some examples, the Source Layer-2 ID and the Destination Layer-2 ID may be assigned by a management function in the Core Network. The Source Layer-2 ID may identify the sender of the data in NR sidelink communication. The Source Layer-2 ID may be 24 bits long and may be split in the MAC layer into two bit strings: One bit string may be the LSB part (8 bits) of Source Layer-2 ID and forwarded to physical layer of the sender. This may identify the source of the intended data in sidelink control information and may be used for filtering of packets at the physical layer of the receiver; and the Second bit string may be the MSB part (16 bits) of the Source Layer-2 ID and may be carried within the Medium Access Control (MAC) header. This may be used for filtering of packets at the MAC layer of the receiver. The Destination Layer-2 ID may identify the target of the data in NR sidelink communication. For NR sidelink communication, the Destination Layer-2 ID may be 24 bits long and may be split in the MAC layer into two bit strings: One bit string may be the LSB part (16 bits) of Destination Layer-2 ID and forwarded to physical layer of the sender. This may identify the target of the intended data in sidelink control information and may be used for filtering of packets at the physical layer of the receiver; and the Second bit string may be the MSB part (8 bits) of the Destination Layer-2 ID and may be carried within the MAC header. This may be used for filtering of packets at the MAC layer of the receiver. The PC5 Link Identifier may uniquely identify the PC5 unicast link in a UE for the lifetime of the PC5 unicast link. The PC5 Link Identifier may be used to indicate the PC5 unicast link whose sidelink Radio Link failure (RLF) declaration was made and PC5-RRC connection was released.

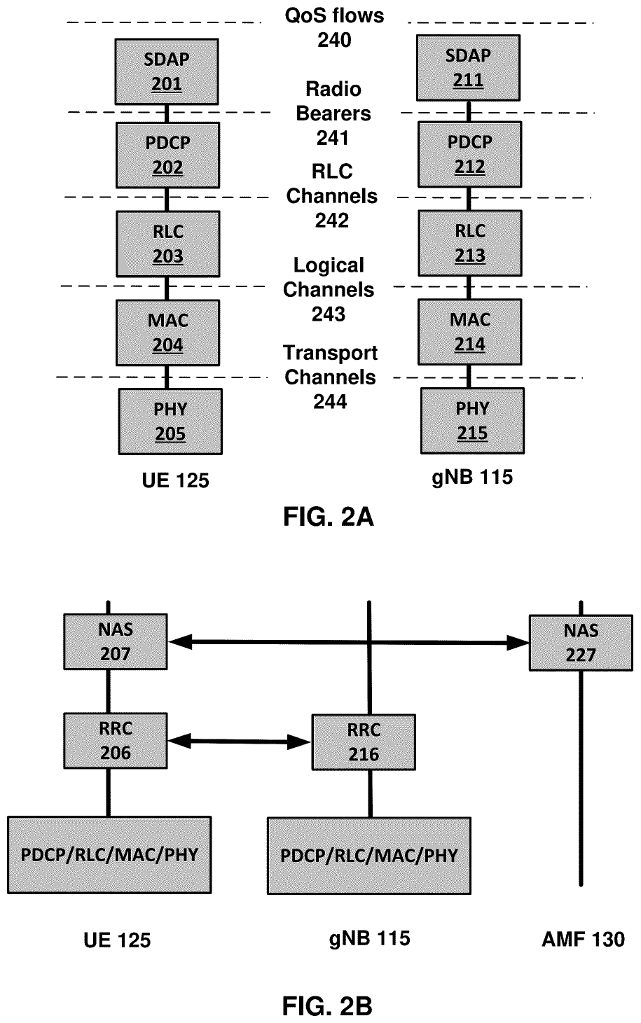

FIG. 2A and FIG. 2B show examples of radio protocol stacks for user plane and control plane, respectively, according to some aspects of some of various exemplary embodiments of the present disclosure. As shown in FIG. 2A, the protocol stack for the user plane of the Uu interface (between the UE 125 and the gNB 115) includes Service Data Adaptation Protocol (SDAP) 201 and SDAP 211, Packet Data Convergence Protocol (PDCP) 202 and PDCP 212, Radio Link Control (RLC) 203 and RLC 213, MAC 204 and MAC 214 sublayers of layer 2 and Physical (PHY) 205 and PHY 215 layer (layer 1 also referred to as L1).

The PHY 205 and PHY 215 offer transport channels 244 to the MAC 204 and MAC 214 sublayer. The MAC 204 and MAC 214 sublayer offer logical channels 243 to the RLC 203 and RLC 213 sublayer. The RLC 203 and RLC 213 sublayer offer RLC channels 242 to the PDCP 202 and PCP 212 sublayer. The PDCP 202 and PDCP 212 sublayer offer radio bearers 241 to the SDAP 201 and SDAP 211 sublayer. Radio bearers may be categorized into two groups: Data Radio Bearers (DRBs) for user plane data and Signaling Radio Bearers (SRBs) for control plane data. The SDAP 201 and SDAP 211 sublayer offers QoS flows 240 to 5GC.

The main services and functions of the MAC 204 or MAC 214 sublayer include: mapping between logical channels and transport channels; Multiplexing/demultiplexing of MAC Service Data Units (SDUs) belonging to one or different logical channels into/from Transport Blocks (TB) delivered to/from the physical layer on transport channels; Scheduling information reporting; Error correction through Hybrid Automatic Repeat Request (HARQ) (one HARQ entity per cell in case of carrier aggregation (CA)); Priority handling between UEs by means of dynamic scheduling; Priority handling between logical channels of one UE by means of Logical Channel Prioritization (LCP); Priority handling between overlapping resources of one UE; and Padding. A single MAC entity may support multiple numerologies, transmission timings and cells. Mapping restrictions in logical channel prioritization control which numerology(ies), cell(s), and transmission timing(s) a logical channel may use.

The HARQ functionality may ensure delivery between peer entities at Layer 1. A single HARQ process may support one TB when the physical layer is not configured for downlink/uplink spatial multiplexing, and when the physical layer is configured for downlink/uplink spatial multiplexing, a single HARQ process may support one or multiple TBs.

The RLC 203 or RLC 213 sublayer may support three transmission modes: Transparent Mode (TM); Unacknowledged Mode (UM); and Acknowledged Mode (AM). The RLC configuration may be per logical channel with no dependency on numerologies and/or transmission durations, and Automatic Repeat Request (ARQ) may operate on any of the numerologies and/or transmission durations the logical channel is configured with.

The main services and functions of the RLC 203 or RLC 213 sublayer depend on the transmission mode (e.g., TM, UM or AM) and may include: Transfer of upper layer PDUs; Sequence numbering independent of the one in PDCP (UM and AM); Error Correction through ARQ (AM only); Segmentation (AM and UM) and re-segmentation (AM only) of RLC SDUs; Reassembly of SDU (AM and UM); Duplicate Detection (AM only); RLC SDU discard (AM and UM); RLC re-establishment; and Protocol error detection (AM only).

The automatic repeat request within the RLC 203 or RLC 213 sublayer may have the following characteristics: ARQ retransmits RLC SDUs or RLC SDU segments based on RLC status reports; Polling for RLC status report may be used when needed by RLC; RLC receiver may also trigger RLC status report after detecting a missing RLC SDU or RLC SDU segment.

The main services and functions of the PDCP 202 or PDCP 212 sublayer may include: Transfer of data (user plane or control plane); Maintenance of PDCP Sequence Numbers (SNs); Header compression and decompression using the Robust Header Compression (ROHC) protocol; Header compression and decompression using EHC protocol; Ciphering and deciphering; Integrity protection and integrity verification; Timer based SDU discard; Routing for split bearers; Duplication; Reordering and in-order delivery; Out-of-order delivery; and Duplicate discarding.

The main services and functions of SDAP 201 or SDAP 211 include: Mapping between a QoS flow and a data radio bearer; and Marking QoS Flow ID (QFI) in both downlink and uplink packets. A single protocol entity of SDAP may be configured for each individual PDU session.

As shown in FIG. 2B, the protocol stack of the control plane of the Uu interface (between the UE 125 and the gNB 115) includes PHY layer (layer 1), and MAC, RLC and PDCP sublayers of layer 2 as described above and in addition, the RRC 206 sublayer and RRC 216 sublayer. The main services and functions of the RRC 206 sublayer and the RRC 216 sublayer over the Uu interface include: Broadcast of System Information related to AS and NAS; Paging initiated by 5GC or NG-RAN; Establishment, maintenance and release of an RRC connection between the UE and NG-RAN (including Addition, modification and release of carrier aggregation; and Addition, modification and release of Dual Connectivity in NR or between E-UTRA and NR); Security functions including key management; Establishment, configuration, maintenance and release of SRBs and DRBs; Mobility functions (including Handover and context transfer; UE cell selection and reselection and control of cell selection and reselection; and Inter-RAT mobility); QoS management functions; UE measurement reporting and control of the reporting; Detection of and recovery from radio link failure; and NAS message transfer to/from NAS from/to UE. The NAS 207 and NAS 227 layer is a control protocol (terminated in AMF on the network side) that performs the functions such as authentication, mobility management, security control, etc.

The sidelink specific services and functions of the RRC sublayer over the Uu interface include: Configuration of sidelink resource allocation via system information or dedicated signaling; Reporting of UE sidelink information; Measurement configuration and reporting related to sidelink; and Reporting of UE assistance information for SL traffic pattern(s).

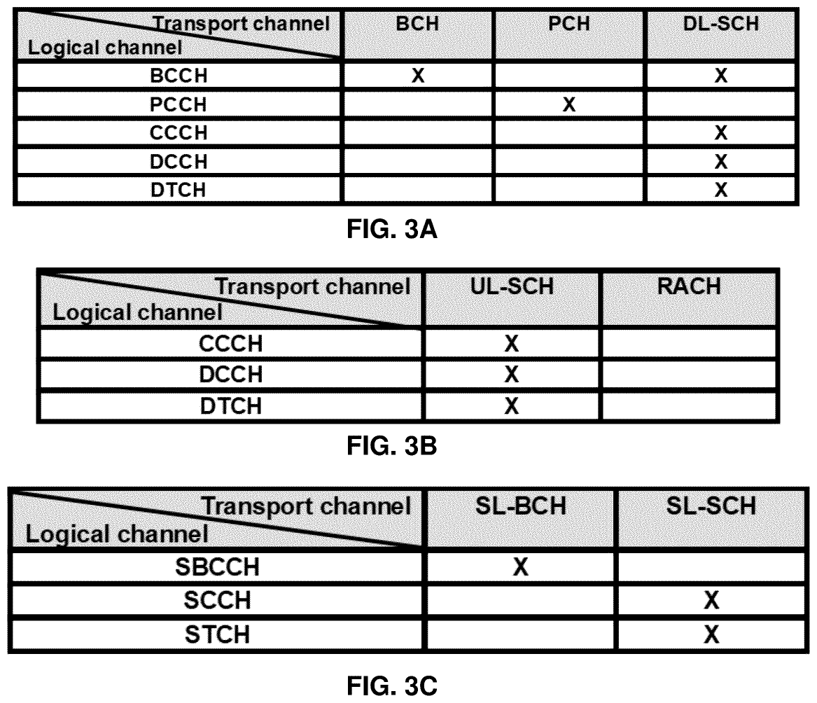

FIG. 3A, FIG. 3B and FIG. 3C show example mappings between logical channels and transport channels in downlink, uplink and sidelink, respectively, according to some aspects of some of various exemplary embodiments of the present disclosure. Different kinds of data transfer services may be offered by MAC. Each logical channel type may be defined by what type of information is transferred. Logical channels may be classified into two groups: Control Channels and Traffic Channels. Control channels may be used for the transfer of control plane information only. The Broadcast Control Channel (BCCH) is a downlink channel for broadcasting system control information. The Paging Control Channel (PCCH) is a downlink channel that carries paging messages. The Common Control Channel (CCCH) is channel for transmitting control information between UEs and network. This channel may be used for UEs having no RRC connection with the network. The Dedicated Control Channel (DCCH) is a point-to-point bi-directional channel that transmits dedicated control information between a UE and the network and may be used by UEs having an RRC connection. Traffic channels may be used for the transfer of user plane information only. The Dedicated Traffic Channel (DTCH) is a point-to-point channel, dedicated to one UE, for the transfer of user information. A DTCH may exist in both uplink and downlink. Sidelink Control Channel (SCCH) is a sidelink channel for transmitting control information (e.g., PC5-RRC and PC5-S messages) from one UE to other UE(s). Sidelink Traffic Channel (STCH) is a sidelink channel for transmitting user information from one UE to other UE(s). Sidelink Broadcast Control Channel (SBCCH) is a sidelink channel for broadcasting sidelink system information from one UE to other UE(s).

The downlink transport channel types include Broadcast Channel (BCH), Downlink Shared Channel (DL-SCH), and Paging Channel (PCH). The BCH may be characterized by: fixed, pre-defined transport format; and requirement to be broadcast in the entire coverage area of the cell, either as a single message or by beamforming different BCH instances. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; and the support for UE Discontinuous Reception (DRX) to enable UE power saving. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; support for UE discontinuous reception (DRX) to enable UE power saving. The PCH may be characterized by: support for UE discontinuous reception (DRX) to enable UE power saving (DRX cycle is indicated by the network to the UE); requirement to be broadcast in the entire coverage area of the cell, either as a single message or by beamforming different BCH instances; mapped to physical resources which can be used dynamically also for traffic/other control channels.

In downlink, the following connections between logical channels and transport channels may exist: BCCH may be mapped to BCH; BCCH may be mapped to DL-SCH; PCCH may be mapped to PCH; CCCH may be mapped to DL-SCH; DCCH may be mapped to DL-SCH; and DTCH may be mapped to DL-SCH.

The uplink transport channel types include Uplink Shared Channel (UL-SCH) and Random Access Channel(s) (RACH). The UL-SCH may be characterized by possibility to use beamforming; support for dynamic link adaptation by varying the transmit power and potentially modulation and coding; support for HARQ; support for both dynamic and semi-static resource allocation. The RACH may be characterized by limited control information; and collision risk.

In Uplink, the following connections between logical channels and transport channels may exist: CCCH may be mapped to UL-SCH; DCCH may be mapped to UL-SCH; and DTCH may be mapped to UL-SCH.

The sidelink transport channel types include: Sidelink broadcast channel (SL-BCH) and Sidelink shared channel (SL-SCH). The SL-BCH may be characterized by pre-defined transport format. The SL-SCH may be characterized by support for unicast transmission, groupcast transmission and broadcast transmission; support for both UE autonomous resource selection and scheduled resource allocation by NG-RAN; support for both dynamic and semi-static resource allocation when UE is allocated resources by the NG-RAN; support for HARQ; and support for dynamic link adaptation by varying the transmit power, modulation and coding.

In the sidelink, the following connections between logical channels and transport channels may exist: SCCH may be mapped to SL-SCH; STCH may be mapped to SL-SCH; and SBCCH may be mapped to SL-BCH.

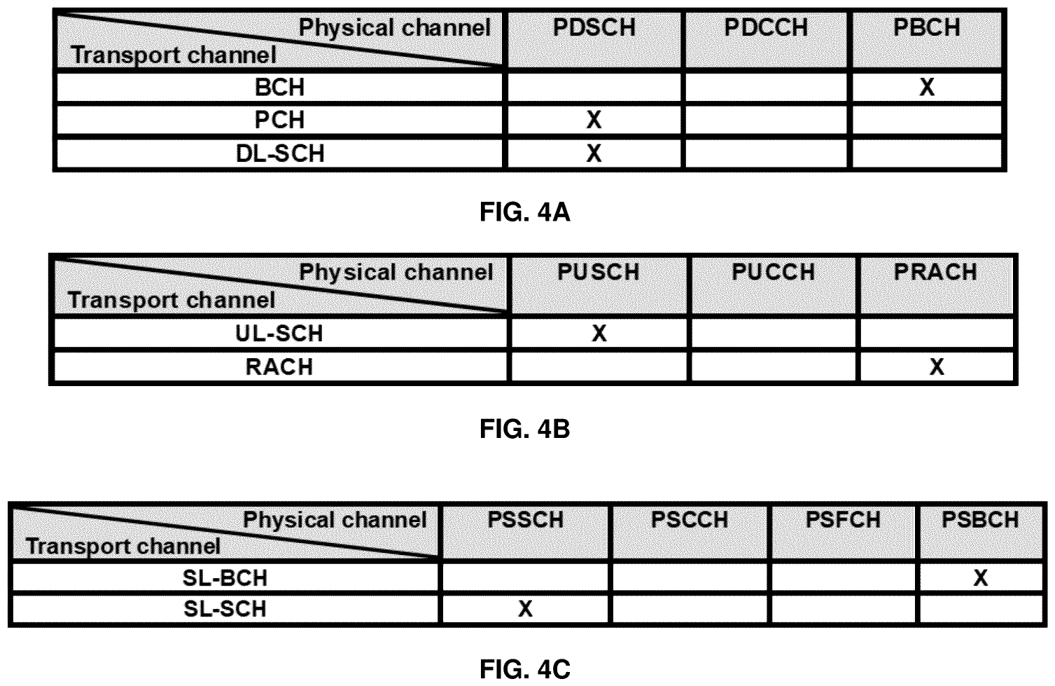

FIG. 4A, FIG. 4B and FIG. 4C show example mappings between transport channels and physical channels in downlink, uplink and sidelink, respectively, according to some aspects of some of various exemplary embodiments of the present disclosure. The physical channels in downlink include Physical Downlink Shared Channel (PDSCH), Physical Downlink Control Channel (PDCCH) and Physical Broadcast Channel (PBCH). The PCH and DL-SCH transport channels are mapped to the PDSCH. The BCH transport channel is mapped to the PBCH. A transport channel is not mapped to the PDCCH but Downlink Control Information (DCI) is transmitted via the PDCCH.

The physical channels in the uplink include Physical Uplink Shared Channel (PUSCH), Physical Uplink Control Channel (PUCCH) and Physical Random Access Channel (PRACH). The UL-SCH transport channel may be mapped to the PUSCH and the RACH transport channel may be mapped to the PRACH. A transport channel is not mapped to the PUCCH but Uplink Control Information (UCI) is transmitted via the PUCCH.

The physical channels in the sidelink include Physical Sidelink Shared Channel (PSSCH), Physical Sidelink Control Channel (PSCCH), Physical Sidelink Feedback Channel (PSFCH) and Physical Sidelink Broadcast Channel (PSBCH). The Physical Sidelink Control Channel (PSCCH) may indicate resource and other transmission parameters used by a UE for PSSCH. The Physical Sidelink Shared Channel (PSSCH) may transmit the TBs of data themselves, and control information for HARQ procedures and CSI feedback triggers, etc. At least 6 OFDM symbols within a slot may be used for PSSCH transmission. Physical Sidelink Feedback Channel (PSFCH) may carry the HARQ feedback over the sidelink from a UE which is an intended recipient of a PSSCH transmission to the UE which performed the transmission. PSFCH sequence may be transmitted in one PRB repeated over two OFDM symbols near the end of the sidelink resource in a slot. The SL-SCH transport channel may be mapped to the PSSCH. The SL-BCH may be mapped to PSBCH. No transport channel is mapped to the PSFCH but Sidelink Feedback Control Information (SFCI) may be mapped to the PSFCH. No transport channel is mapped to PSCCH but Sidelink Control Information (SCI) may be mapped to the PSCCH.

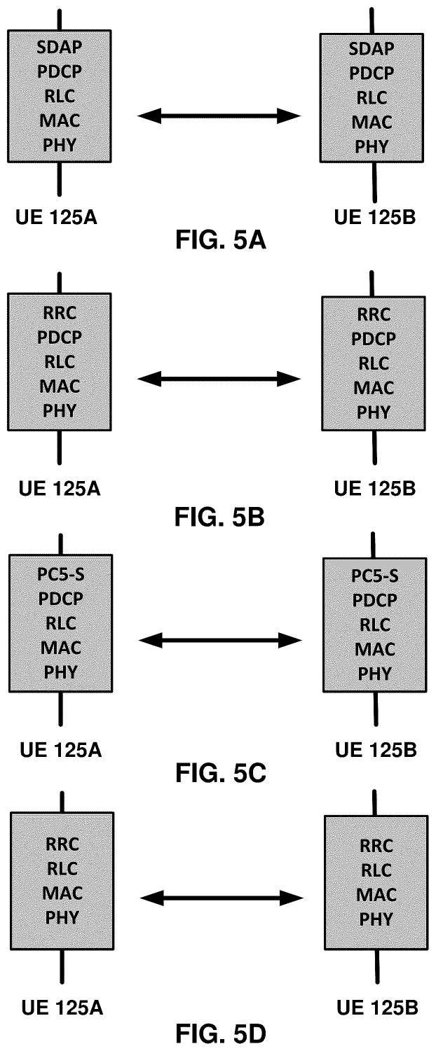

FIG. 5A, FIG. 5B, FIG. 5C and FIG. 5D show examples of radio protocol stacks for NR sidelink communication according to some aspects of some of various exemplary embodiments of the present disclosure. The AS protocol stack for user plane in the PC5 interface (i.e., for STCH) may consist of SDAP, PDCP, RLC and MAC sublayers, and the physical layer. The protocol stack of user plane is shown in FIG. 5A. The AS protocol stack for SBCCH in the PC5 interface may consist of RRC, RLC, MAC sublayers, and the physical layer as shown below in FIG. 5B. For support of PC5-S protocol, PC5-S is located on top of PDCP, RLC and MAC sublayers, and the physical layer in the control plane protocol stack for SCCH for PC5-S, as shown in FIG. 5C. The AS protocol stack for the control plane for SCCH for RRC in the PC5 interface consists of RRC, PDCP, RLC and MAC sublayers, and the physical layer. The protocol stack of control plane for SCCH for RRC is shown in FIG. 5D.

The Sidelink Radio Bearers (SLRBs) may be categorized into two groups: Sidelink Data Radio Bearers (SL DRB) for user plane data and Sidelink Signaling Radio Bearers (SL SRB) for control plane data. Separate SL SRBs using different SCCHs may be configured for PC5-RRC and PC5-S signaling, respectively.

The MAC sublayer may provide the following services and functions over the PC5 interface: Radio resource selection; Packet filtering; Priority handling between uplink and sidelink transmissions for a given UE; and Sidelink CSI reporting. With logical channel prioritization restrictions in MAC, only sidelink logical channels belonging to the same destination may be multiplexed into a MAC PDU for every unicast, groupcast and broadcast transmission which may be associated to the destination. For packet filtering, a SL-SCH MAC header including portions of both Source Layer-2 ID and a Destination Layer-2 ID may be added to a MAC PDU. The Logical Channel Identifier (LCID) included within a MAC subheader may uniquely identify a logical channel within the scope of the Source Layer-2 ID and Destination Layer-2 ID combination.

The services and functions of the RLC sublayer may be supported for sidelink. Both RLC Unacknowledged Mode (UM) and Acknowledged Mode (AM) may be used in unicast transmission while only UM may be used in groupcast or broadcast transmission. For UM, only unidirectional transmission may be supported for groupcast and broadcast.

The services and functions of the PDCP sublayer for the Uu interface may be supported for sidelink with some restrictions: Out-of-order delivery may be supported only for unicast transmission; and Duplication may not be supported over the PC5 interface.

The SDAP sublayer may provide the following service and function over the PC5 interface: Mapping between a QoS flow and a sidelink data radio bearer. There may be one SDAP entity per destination for one of unicast, groupcast and broadcast which is associated to the destination.

The RRC sublayer may provide the following services and functions over the PC5 interface: Transfer of a PC5-RRC message between peer UEs; Maintenance and release of a PC5-RRC connection between two UEs; and Detection of sidelink radio link failure for a PC5-RRC connection based on indication from MAC or RLC. A PC5-RRC connection may be a logical connection between two UEs for a pair of Source and Destination Layer-2 IDs which may be considered to be established after a corresponding PC5 unicast link is established. There may be one-to-one correspondence between the PC5-RRC connection and the PC5 unicast link. A UE may have multiple PC5-RRC connections with one or more UEs for different pairs of Source and Destination Layer-2 IDs. Separate PC5-RRC procedures and messages may be used for a UE to transfer UE capability and sidelink configuration including SL-DRB configuration to the peer UE. Both peer UEs may exchange their own UE capability and sidelink configuration using separate bi-directional procedures in both sidelink directions.

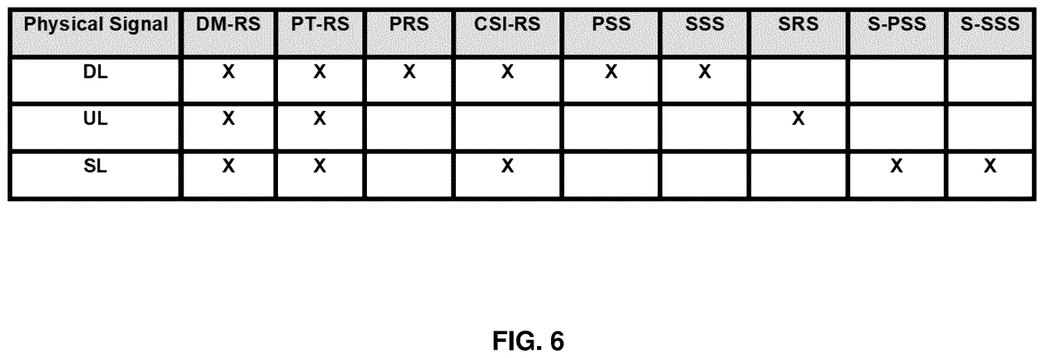

FIG. 6 shows example physical signals in downlink, uplink and sidelink according to some aspects of some of various exemplary embodiments of the present disclosure. The Demodulation Reference Signal (DM-RS) may be used in downlink, uplink and sidelink and may be used for channel estimation. DM-RS is a UE-specific reference signal and may be transmitted together with a physical channel in downlink, uplink or sidelink and may be used for channel estimation and coherent detection of the physical channel. The Phase Tracking Reference Signal (PT-RS) may be used in downlink, uplink and sidelink and may be used for tracking the phase and mitigating the performance loss due to phase noise. The PT-RS may be used mainly to estimate and minimize the effect of Common Phase Error (CPE) on system performance. Due to the phase noise properties, PT-RS signal may have a low density in the frequency domain and a high density in the time domain. PT-RS may occur in combination with DM-RS and when the network has configured PT-RS to be present. The Positioning Reference Signal (PRS) may be used in downlink for positioning using different positioning techniques. PRS may be used to measure the delays of the downlink transmissions by correlating the received signal from the base station with a local replica in the receiver. The Channel State Information Reference Signal (CSI-RS) may be used in downlink and sidelink. CSI-RS may be used for channel state estimation, Reference Signal Received Power (RSRP) measurement for mobility and beam management, time/frequency tracking for demodulation among other uses. CSI-RS may be configured UE-specifically but multiple users may share the same CSI-RS resource. The UE may determine CSI reports and transit them in the uplink to the base station using PUCCH or PUSCH. The CSI report may be carried in a sidelink MAC CE. The Primary Synchronization Signal (PSS) and the Secondary Synchronization Signal (SSS) may be used for radio fame synchronization. The PSS and SSS may be used for the cell search procedure during the initial attach or for mobility purposes. The Sounding Reference Signal (SRS) may be used in uplink for uplink channel estimation. Similar to CSI-RS, the SRS may serve as QCL reference for other physical channels such that they can be configured and transmitted quasi-collocated with SRS. The Sidelink PSS (S-PSS) and Sidelink SSS (S-SSS) may be used in sidelink for sidelink synchronization.

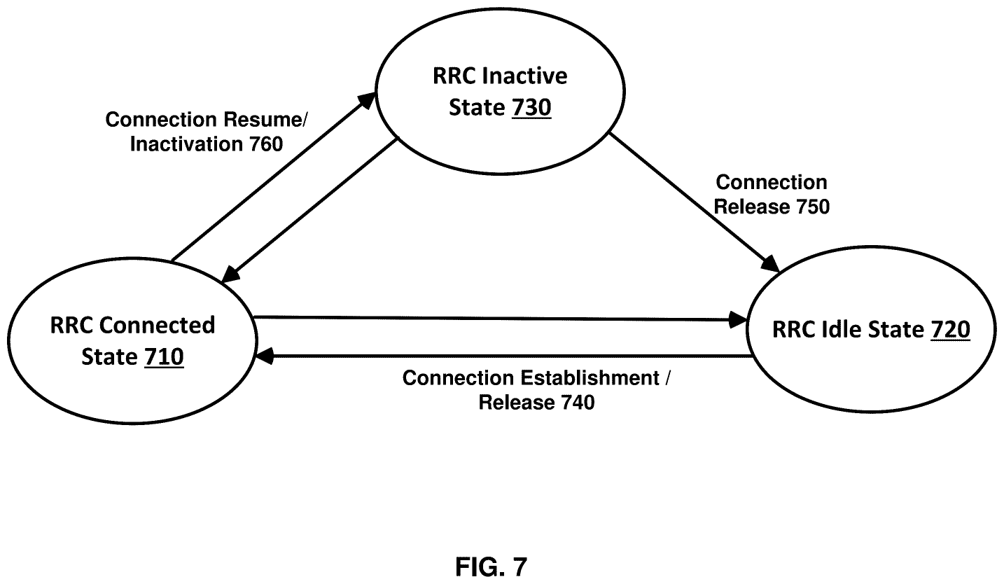

FIG. 7 shows examples of Radio Resource Control (RRC) states and transitioning between different RRC states according to some aspects of some of various exemplary embodiments of the present disclosure. A UE may be in one of three RRC states: RRC Connected State 710, RRC Idle State 720 and RRC Inactive state 730. After power up, the UE may be in RRC Idle state 720 and the UE may establish connection with the network using initial access and via an RRC connection establishment procedure to perform data transfer and/or to make/receive voice calls. Once RRC connection is established, the UE may be in RRC Connected State 710. The UE may transition from the RRC Idle state 720 to the RRC connected state 710 or from the RRC Connected State 710 to the RRC Idle state 720 using the RRC connection Establishment/Release procedures 740.

To reduce the signaling load and the latency resulting from frequent transitioning from the RRC Connected State 710 to the RRC Idle State 720 when the UE transmits frequent small data, the RRC Inactive State 730 may be used. In the RRC Inactive State 730, the AS context may be stored by both UE and gNB. This may result in faster state transition from the RRC Inactive State 730 to RRC Connected State 710. The UE may transition from the RRC Inactive State 730 to the RRC Connected State 710 or from the RRC Connected State 710 to the RRC Inactive State 730 using the RRC Connection Resume/Inactivation procedures 760. The UE may transition from the RRC Inactive State 730 to RRC Idle State 720 using an RRC Connection Release procedure 750.

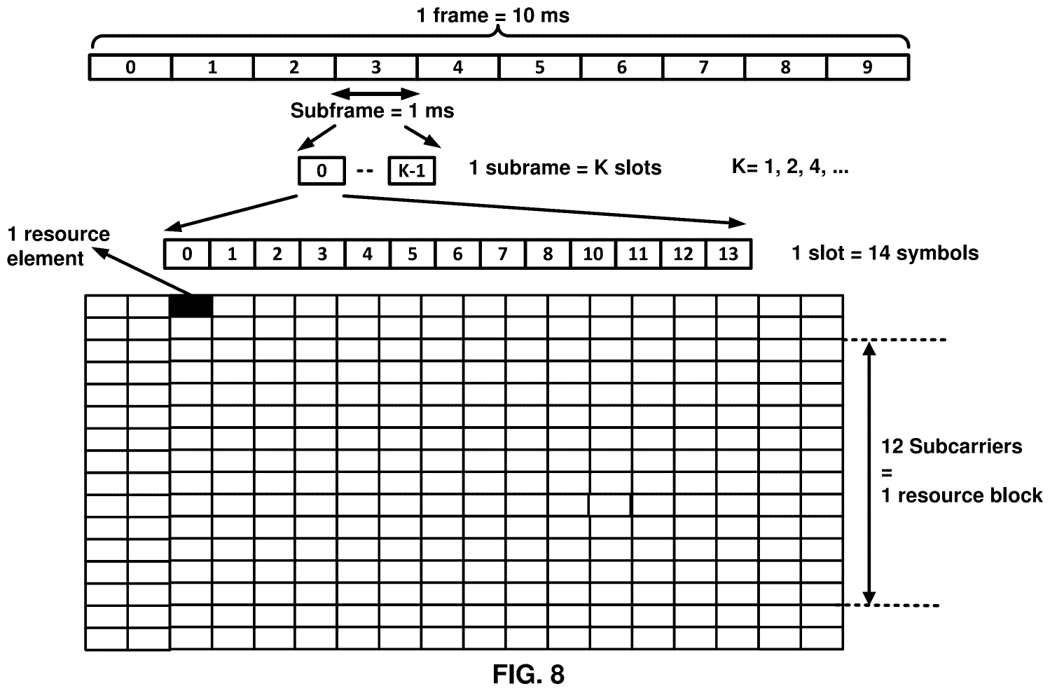

FIG. 8 shows example frame structure and physical resources according to some aspects of some of various exemplary embodiments of the present disclosure. The downlink or uplink or sidelink transmissions may be organized into frames with 10 ms duration, consisting of ten 1 ms subframes. Each subframe may consist of 1, 2, 4, . . . slots, wherein the number of slots per subframe may depend of the subcarrier spacing of the carrier on which the transmission takes place. The slot duration may be 14 symbols with Normal Cyclic Prefix (CP) and 12 symbols with Extended CP and may scale in time as a function of the used sub-carrier spacing so that there is an integer number of slots in a subframe. FIG. 8 shows a resource grid in time and frequency domain. Each element of the resource grid, comprising one symbol in time and one subcarrier in frequency, is referred to as a Resource Element (RE). A Resource Block (RB) may be defined as 12 consecutive subcarriers in the frequency domain.

In some examples and with non-slot-based scheduling, the transmission of a packet may occur over a portion of a slot, for example during 2, 4 or 7 OFDM symbols which may also be referred to as mini-slots. The mini-slots may be used for low latency applications such as URLLC and operation in unlicensed bands. In some embodiments, the mini-slots may also be used for fast flexible scheduling of services (e.g., pre-emption of URLLC over eMBB).

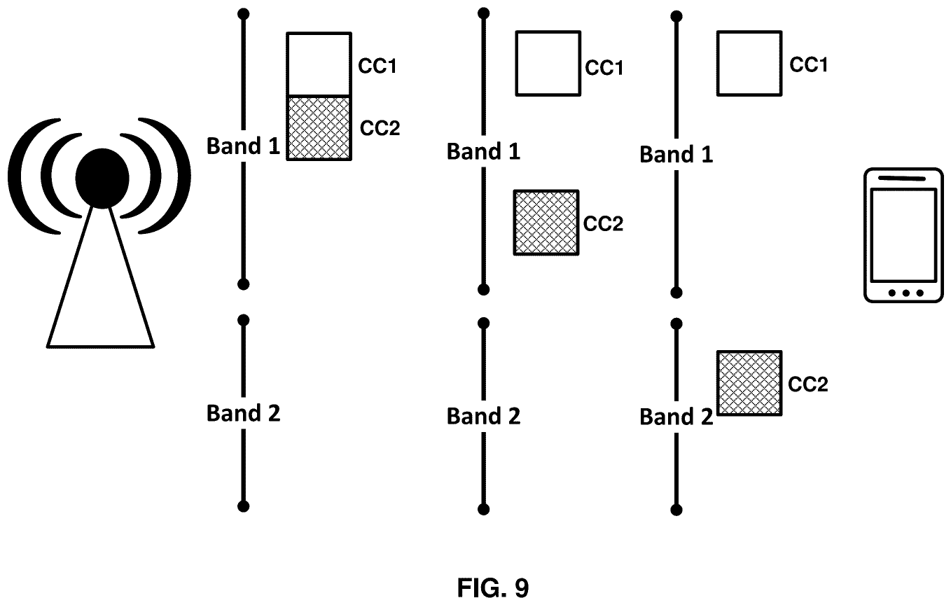

FIG. 9 shows example component carrier configurations in different carrier aggregation scenarios according to some aspects of some of various exemplary embodiments of the present disclosure. In Carrier Aggregation (CA), two or more Component Carriers (CCs) may be aggregated. A UE may simultaneously receive or transmit on one or multiple CCs depending on its capabilities. CA may be supported for both contiguous and non-contiguous CCs in the same band or on different bands as shown in FIG. 9. A gNB and the UE may communicate using a serving cell. A serving cell may be associated at least with one downlink CC (e.g., may be associated only with one downlink CC or may be associated with a downlink CC and an uplink CC). A serving cell may be a Primary Cell (PCell) or a Secondary cCell (SCell).

A UE may adjust the timing of its uplink transmissions using an uplink timing control procedure. A Timing Advance (TA) may be used to adjust the uplink frame timing relative to the downlink frame timing. The gNB may determine the desired Timing Advance setting and provides that to the UE. The UE may use the provided TA to determine its uplink transmit timing relative to the UE's observed downlink receive timing.

In the RRC Connected state, the gNB may be responsible for maintaining the timing advance to keep the L1 synchronized. Serving cells having uplink to which the same timing advance applies and using the same timing reference cell are grouped in a Timing Advance Group (TAG). A TAG may contain at least one serving cell with configured uplink. The mapping of a serving cell to a TAG may be configured by RRC. For the primary TAG, the UE may use the PCell as timing reference cell, except with shared spectrum channel access where an SCell may also be used as timing reference cell in certain cases. In a secondary TAG, the UE may use any of the activated SCells of this TAG as a timing reference cell and may not change it unless necessary.

Timing advance updates may be signaled by the gNB to the UE via MAC CE commands. Such commands may restart a TAG-specific timer which may indicate whether the L1 can be synchronized or not: when the timer is running, the L1 may be considered synchronized, otherwise, the L1 may be considered non-synchronized (in which case uplink transmission may only take place on PRACH).

A UE with single timing advance capability for CA may simultaneously receive and/or transmit on multiple CCs corresponding to multiple serving cells sharing the same timing advance (multiple serving cells grouped in one TAG). A UE with multiple timing advance capability for CA may simultaneously receive and/or transmit on multiple CCs corresponding to multiple serving cells with different timing advances (multiple serving cells grouped in multiple TAGs). The NG-RAN may ensure that each TAG contains at least one serving cell. A non-CA capable UE may receive on a single CC and may transmit on a single CC corresponding to one serving cell only (one serving cell in one TAG).

The multi-carrier nature of the physical layer in case of CA may be exposed to the MAC layer and one HARQ entity may be required per serving cell. When CA is configured, the UE may have one RRC connection with the network. At RRC connection establishment/re-establishment/handover, one serving cell (e.g., the PCell) may provide the NAS mobility information. Depending on UE capabilities, SCells may be configured to form together with the PCell a set of serving cells. The configured set of serving cells for a UE may consist of one PCell and one or more SCells. The reconfiguration, addition and removal of SCells may be performed by RRC.

In a dual connectivity scenario, a UE may be configured with a plurality of cells comprising a Master Cell Group (MCG) for communications with a master base station, a Secondary Cell Group (SCG) for communications with a secondary base station, and two MAC entities: one MAC entity and for the MCG for communications with the master base station and one MAC entity for the SCG for communications with the secondary base station.

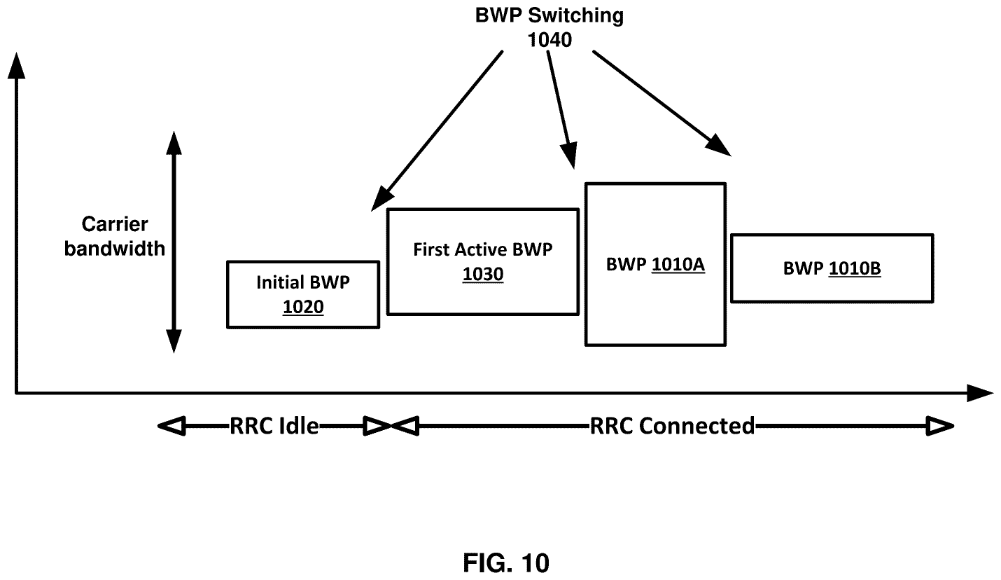

FIG. 10 shows example bandwidth part configuration and switching according to some aspects of some of various exemplary embodiments of the present disclosure. The UE may be configured with one or more Bandwidth Parts (BWPs) 1010 on a given component carrier. In some examples, one of the one or more bandwidth parts may be active at a time. The active bandwidth part may define the UE's operating bandwidth within the cell's operating bandwidth. For initial access, and until the UE's configuration in a cell is received, initial bandwidth part 1020 determined from system information may be used. With Bandwidth Adaptation (BA), for example through BWP switching 1040, the receive and transmit bandwidth of a UE may not be as large as the bandwidth of the cell and may be adjusted. For example, the width may be ordered to change (e.g. to shrink during period of low activity to save power); the location may move in the frequency domain (e.g. to increase scheduling flexibility); and the subcarrier spacing may be ordered to change (e.g. to allow different services). The first active BWP 1020 may be the active BWP upon RRC (re-) configuration for a PCell or activation of an SCell.

For a downlink BWP or uplink BWP in a set of downlink BWPs or uplink BWPs, respectively, the UE may be provided the following configuration parameters: a Subcarrier Spacing (SCS); a cyclic prefix; a common RB and a number of contiguous RBs; an index in the set of downlink BWPs or uplink BWPs by respective BWP-Id; a set of BWP-common and a set of BWP-dedicated parameters. A BWP may be associated with an OFDM numerology according to the configured subcarrier spacing and cyclic prefix for the BWP. For a serving cell, a UE may be provided by a default downlink BWP among the configured downlink BWPs. If a UE is not provided a default downlink BWP, the default downlink BWP may be the initial downlink BWP.

A downlink BWP may be associated with a BWP inactivity timer. If the BWP inactivity timer associated with the active downlink BWP expires and if the default downlink BWP is configured, the UE may perform BWP switching to the default BWP. If the BWP inactivity timer associated with the active downlink BWP expires and if the default downlink BWP is not configured, the UE may perform BWP switching to the initial downlink BWP.

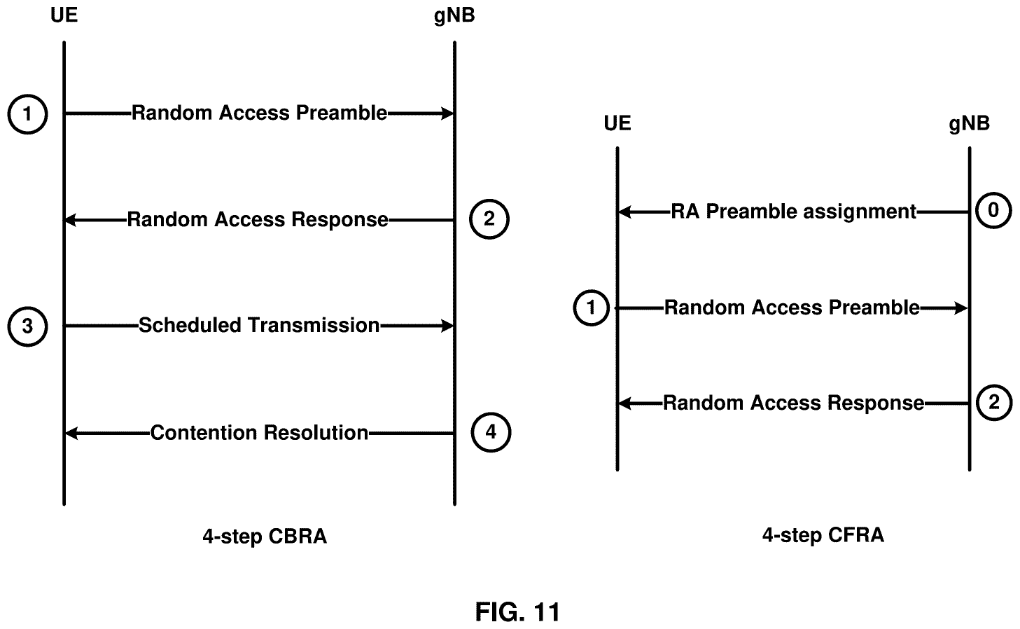

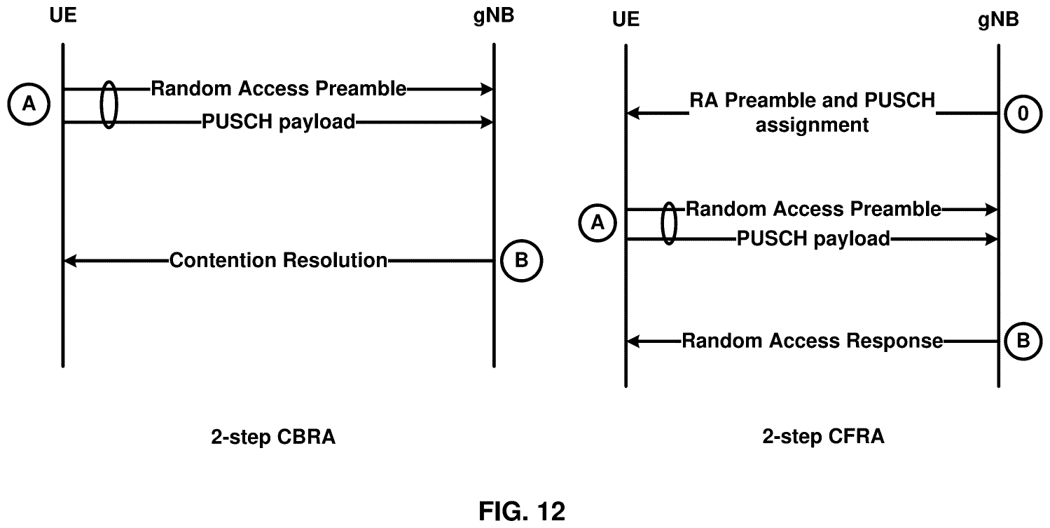

FIG. 11 shows example four-step contention-based and contention-free random access processes according to some aspects of some of various exemplary embodiments of the present disclosure. FIG. 12 shows example two-step contention-based and contention-free random access processes according to some aspects of some of various exemplary embodiments of the present disclosure. The random access procedure may be triggered by a number of events, for example: Initial access from RRC Idle State; RRC Connection Re-establishment procedure; downlink or uplink data arrival during RRC Connected State when uplink synchronization status is “non-synchronized”; uplink data arrival during RRC Connected State when there are no PUCCH resources for Scheduling Request (SR) available; SR failure; Request by RRC upon synchronous reconfiguration (e.g. handover); Transition from RRC Inactive State; to establish time alignment for a secondary TAG; Request for Other System Information (SI); Beam Failure Recovery (BFR); Consistent uplink Listen-Before-Talk (LBT) failure on PCell.

Two types of Random Access (RA) procedure may be supported: 4-step RA type with MSG1 and 2-step RA type with MSGA. Both types of RA procedure may support Contention-Based Random Access (CBRA) and Contention-Free Random Access (CFRA) as shown in FIG. 11 and FIG. 12.

The UE may select the type of random access at initiation of the random access procedure based on network configuration. When CFRA resources are not configured, a RSRP threshold may be used by the UE to select between 2-step RA type and 4-step RA type. When CFRA resources for 4-step RA type are configured, UE may perform random access with 4-step RA type. When CFRA resources for 2-step RA type are configured, UE may perform random access with 2-step RA type.

The MSG1 of the 4-step RA type may consist of a preamble on PRACH. After MSG1 transmission, the UE may monitor for a response from the network within a configured window. For CFRA, dedicated preamble for MSG1 transmission may be assigned by the network and upon receiving Random Access Response (RAR) from the network, the UE may end the random access procedure as shown in FIG. 11. For CBRA, upon reception of the random access response, the UE may send MSG3 using the uplink grant scheduled in the random access response and may monitor contention resolution as shown in FIG. 11. If contention resolution is not successful after MSG3 (re)transmission(s), the UE may go back to MSG1 transmission.

The MSGA of the 2-step RA type may include a preamble on PRACH and a payload on PUSCH. After MSGA transmission, the UE may monitor for a response from the network within a configured window. For CFRA, dedicated preamble and PUSCH resource may be configured for MSGA transmission and upon receiving the network response, the UE may end the random access procedure as shown in FIG. 12. For CBRA, if contention resolution is successful upon receiving the network response, the UE may end the random access procedure as shown in FIG. 12; while if fallback indication is received in MSGB, the UE may perform MSG3 transmission using the uplink grant scheduled in the fallback indication and may monitor contention resolution. If contention resolution is not successful after MSG3 (re)transmission(s), the UE may go back to MSGA transmission.

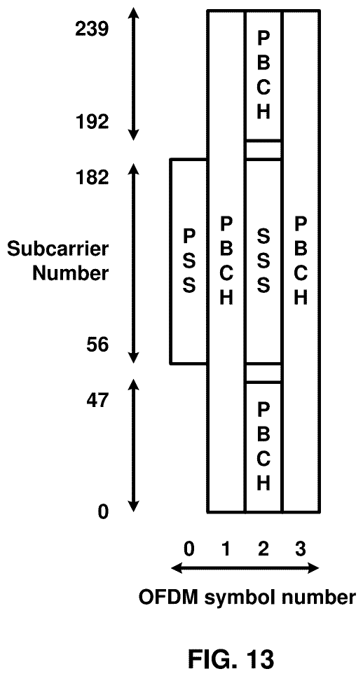

FIG. 13 shows example time and frequency structure of Synchronization Signal and Physical Broadcast Channel (PBCH) Block (SSB) according to some aspects of some of various exemplary embodiments of the present disclosure. The SS/PBCH Block (SSB) may consist of Primary and Secondary Synchronization Signals (PSS, SSS), each occupying 1 symbol and 127 subcarriers (e.g., subcarrier numbers 56 to 182 in FIG. 13), and PBCH spanning across 3 OFDM symbols and 240 subcarriers, but on one symbol leaving an unused part in the middle for SSS as show in FIG. 13. The possible time locations of SSBs within a half-frame may be determined by sub-carrier spacing and the periodicity of the half-frames, where SSBs are transmitted, may be configured by the network. During a half-frame, different SSBs may be transmitted in different spatial directions (i.e. using different beams, spanning the coverage area of a cell).

The PBCH may be used to carry Master Information Block (MIB) used by a UE during cell search and initial access procedures. The UE may first decode PBCH/MIB to receive other system information. The MIB may provide the UE with parameters required to acquire System Information Block 1 (SIB1), more specifically, information required for monitoring of PDCCH for scheduling PDSCH that carries SIB1. In addition, MIB may indicate cell barred status information. The MIB and SIB1 may be collectively referred to as the minimum system information (SI) and SIB1 may be referred to as remaining minimum system information (RMSI). The other system information blocks (SIBS) (e.g., SIB2, SIB3, . . . , SIB10 and SIBpos) may be referred to as Other SI. The Other SI may be periodically broadcast on DL-SCH, broadcast on-demand on DL-SCH (e.g., upon request from UEs in RRC Idle State, RRC Inactive State, or RRC connected State), or sent in a dedicated manner on DL-SCH to UEs in RRC Connected State (e.g., upon request, if configured by the network, from UEs in RRC Connected State or when the UE has an active BWP with no common search space configured).

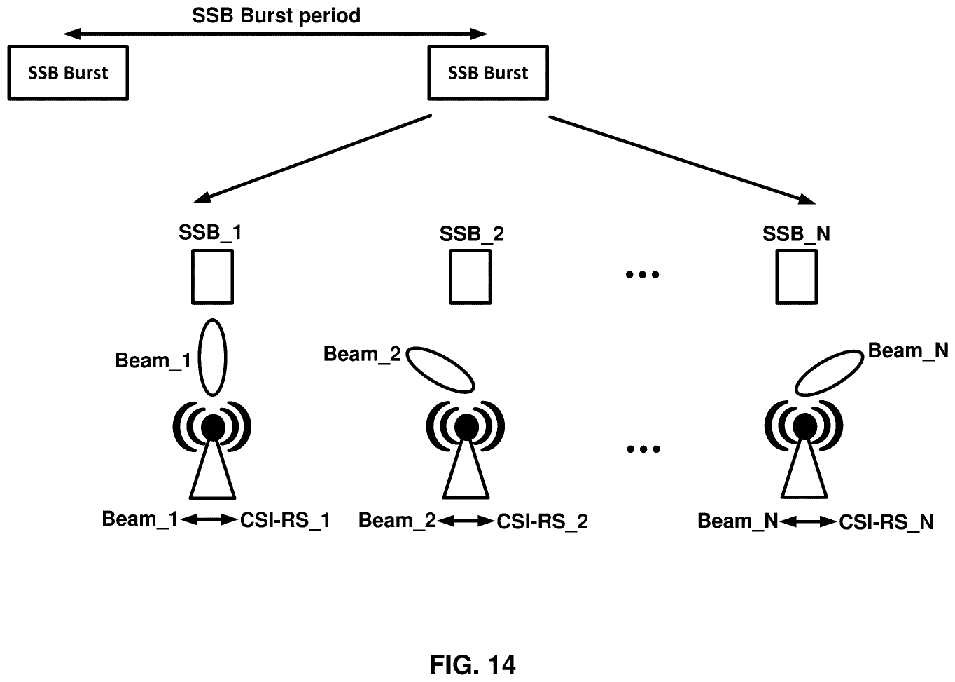

FIG. 14 shows example SSB burst transmissions according to some aspects of some of various exemplary embodiments of the present disclosure. An SSB burst may include N SSBs and each SSB of the N SSBs may correspond to a beam. The SSB bursts may be transmitted according to a periodicity (e.g., SSB burst period). During a contention-based random access process, a UE may perform a random access resource selection process, wherein the UE first selects an SSB before selecting a RA preamble. The UE may select an SSB with an RSRP above a configured threshold value. In some embodiments, the UE may select any SSB if no SSB with RSRP above the configured threshold is available. A set of random access preambles may be associated with an SSB. After selecting an SSB, the UE may select a random access preamble from the set of random access preambles associated with the SSB and may transmit the selected random access preamble to start the random access process.

In some embodiments, a beam of the N beams may be associated with a CSI-RS resource. A UE may measure CSI-RS resources and may select a CSI-RS with RSRP above a configured threshold value. The UE may select a random access preamble corresponding to the selected CSI-RS and may transmit the selected random access process to start the random access process. If there is no random access preamble associated with the selected CSI-RS, the UE may select a random access preamble corresponding to an SSB which is Quasi-Collocated with the selected CSI-RS.

In some embodiments, based on the UE measurements of the CSI-RS resources and the UE CSI reporting, the base station may determine a Transmission Configuration Indication (TCI) state and may indicate the TCI state to the UE, wherein the UE may use the indicated TCI state for reception of downlink control information (e.g., via PDCCH) or data (e.g., via PDSCH). The UE may use the indicated TCI state for using the appropriate beam for reception of data or control information. The indication of the TCI states may be using RRC configuration or in combination of RRC signaling and dynamic signaling (e.g., via a MAC Control element (MAC CE) and/or based on a value of field in the downlink control information that schedules the downlink transmission). The TCI state may indicate a Quasi-Colocation (QCL) relationship between a downlink reference signal such as CSI-RS and the DM-RS associated with the downlink control or data channels (e.g., PDCCH or PDSCH, respectively).

In some embodiments, the UE may be configured with a list of up to M TCI-State configurations, using Physical Downlink Shared Channel (PDSCH) configuration parameters, to decode PDSCH according to a detected PDCCH with DCI intended for the UE and the given serving cell, where M may depends on the UE capability. Each TCI-State may contain parameters for configuring a QCL relationship between one or two downlink reference signals and the DM-RS ports of the PDSCH, the DM-RS port of PDCCH or the CSI-RS port(s) of a CSI-RS resource. The quasi co-location relationship may be configured by one or more RRC parameters. The quasi co-location types corresponding to each DL RS may take one of the following values: ‘QCL-TypeA’: {Doppler shift, Doppler spread, average delay, delay spread}; ‘QCL-TypeB’: {Doppler shift, Doppler spread}; ‘QCL-TypeC’: {Doppler shift, average delay}; ‘QCL-TypeD’: {Spatial Rx parameter}. The UE may receive an activation command (e.g., a MAC CE), used to map TCI states to the codepoints of a DCI field.

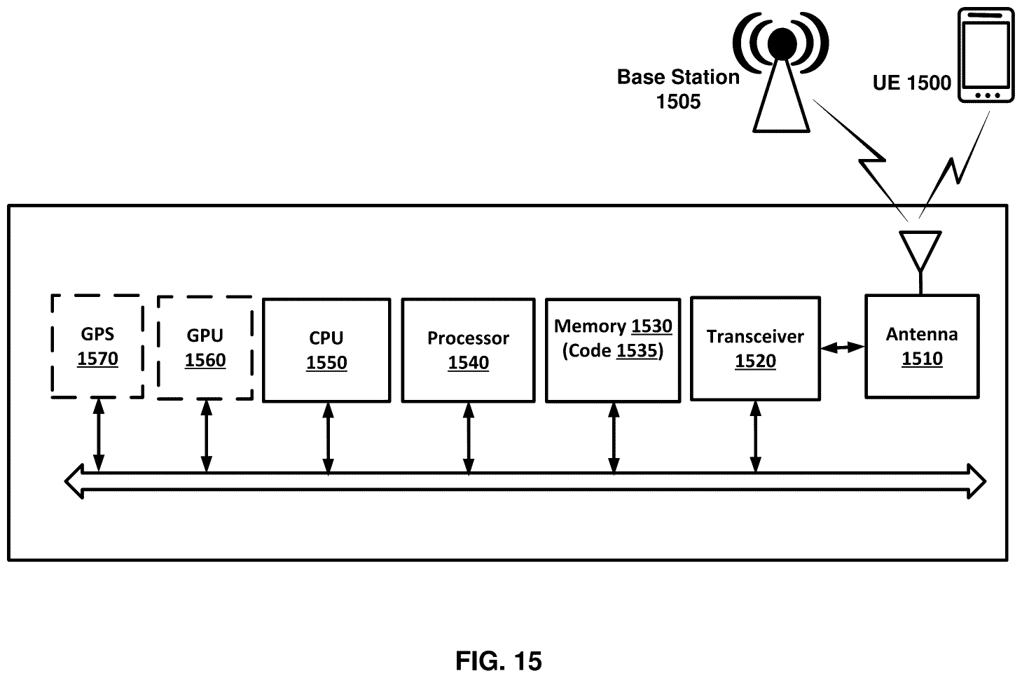

FIG. 15 shows example components of a user equipment and a base station for transmission and/or reception according to some aspects of some of various exemplary embodiments of the present disclosure. In one embodiment, the illustrative components of FIG. 15 may be considered to be illustrative of functional blocks of an illustrative base station 1505. In another embodiment, the illustrative components of FIG. 15 may be considered to be illustrative of functional blocks of an illustrative user equipment 1500. Accordingly, the components illustrated in FIG. 15 are not necessarily limited to either a user equipment or base station.

With reference to FIG. 15, the Antenna 1510 may be used for transmission or reception of electromagnetic signals. The Antenna 1510 may comprise one or more antenna elements and may enable different input-output antenna configurations including Multiple-Input Multiple Output (MIMO) configuration, Multiple-Input Single-Output (MISO) configuration and Single-Input Multiple-Output (SIMO) configuration. In some embodiments, the Antenna 150 may enable a massive MIMO configuration with tens or hundreds of antenna elements. The Antenna 1510 may enable other multi-antenna techniques such as beamforming. In some examples and depending on the UE 1500 capabilities or the type of UE 1500 (e.g., a low-complexity UE), the UE 1500 may support a single antenna only.

The transceiver 1520 may communicate bi-directionally, via the Antenna 1510, wireless links as described herein. For example, the transceiver 1520 may represent a wireless transceiver at the UE and may communicate bi-directionally with the wireless transceiver at the base station or vice versa. The transceiver 1520 may include a modem to modulate the packets and provide the modulated packets to the Antennas 1510 for transmission, and to demodulate packets received from the Antennas 1510.

The memory 1530 may include RAM and ROM. The memory 1530 may store computer-readable, computer-executable code 1535 including instructions that, when executed, cause the processor to perform various functions described herein. In some examples, the memory 1530 may contain, among other things, a Basic Input/output System (BIOS) which may control basic hardware or software operation such as the interaction with peripheral components or devices.

The processor 1540 may include a hardware device with processing capability (e.g., a general purpose processor, a DSP, a CPU, a microcontroller, an ASIC, an FPGA, a programmable logic device, a discrete gate or transistor logic component, a discrete hardware component, or any combination thereof). In some examples, the processor 1540 may be configured to operate a memory using a memory controller. In other examples, a memory controller may be integrated into the processor 1540. The processor 1540 may be configured to execute computer-readable instructions stored in a memory (e.g., the memory 1530) to cause the UE 1500 or the base station 1505 to perform various functions.

The Central Processing Unit (CPU) 1550 may perform basic arithmetic, logic, controlling, and Input/output (I/O) operations specified by the computer instructions in the Memory 1530. The user equipment 1500 and/or the base station 1505 may include additional peripheral components such as a graphics processing unit (GPU) 1560 and a Global Positioning System (GPS) 1570. The GPU 1560 is a specialized circuitry for rapid manipulation and altering of the Memory 1530 for accelerating the processing performance of the user equipment 1500 and/or the base station 1505. The GPS 1570 may be used for enabling location-based services or other services for example based on geographical position of the user equipment 1500.

Convolutional coding may be used in some example embodiments in the present disclosure. The output code bits (encoded bits) of a convolutional encoder may be determined by logic operations on the present bit in a stream and a small number of previous bits. In the encoder, data bits may be input to a shift register of length K, called the constraint length. As each bit enters at the left of the register, the previous bits may be shifted to the right while the oldest bit in the register is removed. Two or more binary summing operations, let's say r, may create code bits which may be output during one data flow period. The code bit rate may be 1/r times the data rate and the encoder may be called a rate 1/r convolutional encoder of constraint length K. The connections from stages in the shift register to the r summing blocks may be defined based on generator vectors each of which may be simply expressed as a row of K binary digits. The r binary adders may create even parity bits at their outputs; that is, connections to an odd number of logic “ones” may result in an output of “one,” otherwise the output may be “zero.”

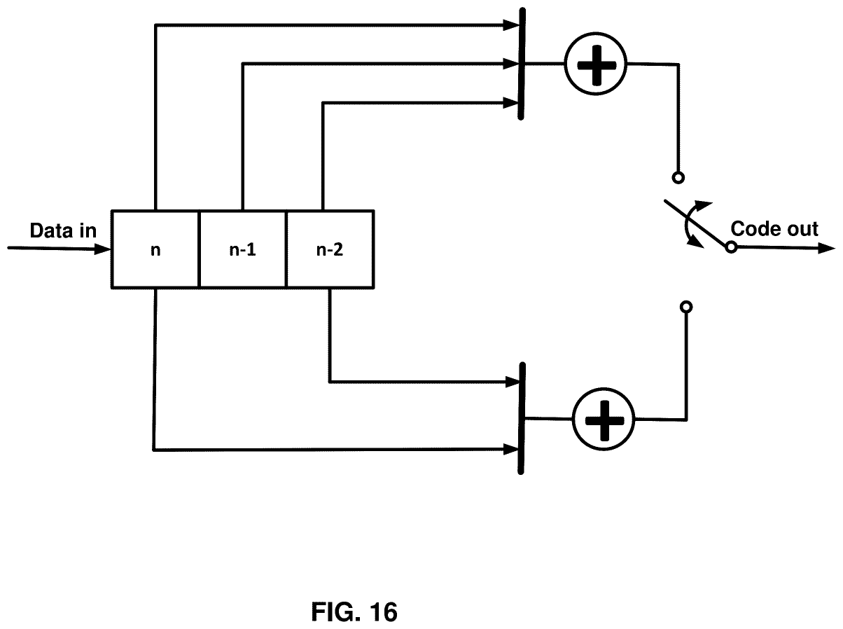

FIG. 16 shows an example with K=3, r=2, and the generator vectors are chosen as [1 1 1] and [1 0 1]. Discrete sampling times are labeled n. The data stream enters on the left and the present bit at time n, the most recent bit n−1 and the next earliest bit at n−2 may occupy the shift register. Two parity bits may be switched out in the interval between n and n−1 from the upper adder and then the lower one. When the next data bit arrives, the shift register may move its contents to the right. The K−1 earlier bits, in this case two, may determine the state of the encoder. There may be 2K−1 states. For each encoder state there may be two possibilities of output code bits, depending on whether the input bit is “zero” or “one.” The progression of states in time may be a function of the data stream.

Polar coding may be used in some example embodiments in the present disclosure. The polar codes may be based on the concatenation of several basic polarization kernels. By construction, polar codes may allow for code lengths that are powers of two, in the form N=2ⁿ. The code dimension K, e.g., the number of information bits transmitted, may take any arbitrary value. The goal of code design of an (N, K) polar code may be to identify the K best synthetic channels, namely the channels providing the highest reliability, and use them to transmit the information bits.

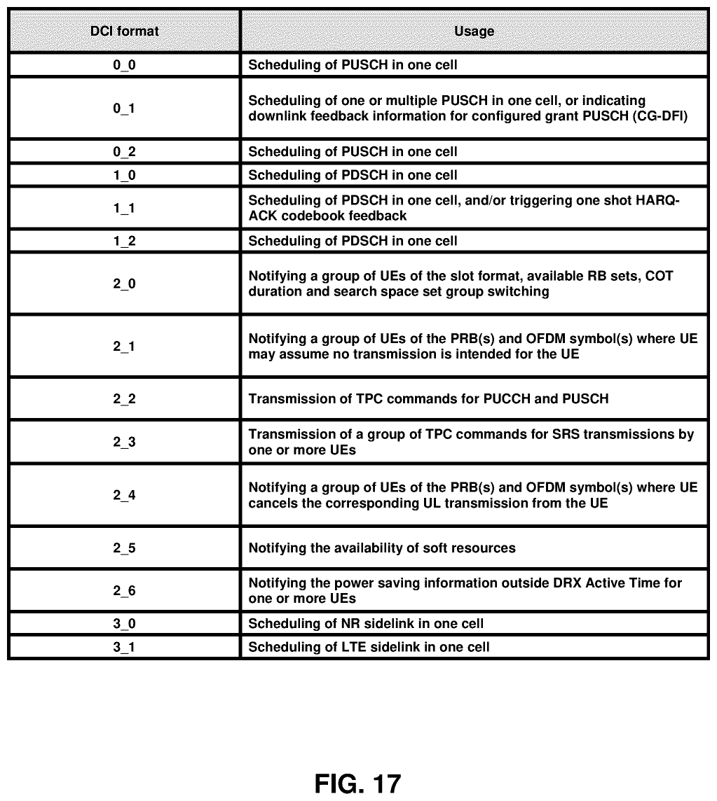

In some examples, DCI may transport downlink control information for one or more cells with an RNTI. The following coding steps may be identified: Information element multiplexing; CRC attachment; Channel coding and Rate matching. Example DCI formats and their usage are shown in FIG. 17.

In some examples, the fields in a DCI format may be mapped to the information bits α₀ to α_{A-1}. Each field may be mapped in the order in which it appears in the description, including the padding bit(s) (e.g., zero-padding bit(s), if any) with the first field mapped to the lowest order information bit α₀ and each successive field mapped to higher order information bits. The most significant bit of each field may be mapped to the lowest order information bit for that field, e.g. the most significant bit of the first field may be mapped to α₀. In some examples, if the number of information bits in a DCI format is less than 12 bits, zeros may be appended to the DCI format until the payload size equals 12. In some examples, the size of a DCI format may be determined by the configuration of the corresponding active bandwidth part of the scheduled cell and may be adjusted if necessary.

In some examples, if necessary, padding or truncation may be applied to the DCI formats based on a DCI alignment process and according to the following steps.

Step 0: Determine DCI format 0_0 monitored in a common search space. Determine DCI format 1_0 monitored in a common search space. If DCI format 0_0 is monitored in common search space and if the number of information bits in the DCI format 0_0 prior to padding is less than the payload size of the DCI format 1_0 monitored in common search space for scheduling the same serving cell, a number padding bits (e.g., of zero padding bits) may be generated for the DCI format 0_0 until the payload size equals that of the DCI format 1_0. If DCI format 0_0 is monitored in common search space and if the number of information bits in the DCI format 0_0 prior to truncation is larger than the payload size of the DCI format 1_0 monitored in common search space for scheduling the same serving cell, the bitwidth of the frequency domain resource assignment field in the DCI format 0_0 may be reduced by truncating the first few most significant bits such that the size of DCI format 0_0 equals the size of the DCI format 1_0.

Step 1: Determine DCI format 0_0 monitored in a UE-specific search space. Determine DCI format 1_0 monitored in a UE-specific search space. For a UE configured with supplementaryUplink in ServingCellConfig in a cell, if PUSCH is configured to be transmitted on both the supplementary uplink (SUL) and the non-SUL of the cell and if the number of information bits in DCI format 0 0 in UE-specific search space for the SUL is not equal to the number of information bits in DCI format 0_0 in UE-specific search space for the non-SUL, a number of padding bits (e.g., zero padding bits) may be generated for the smaller DCI format 0_0 until the payload size equals that of the larger DCI format 0_0. If DCI format 0_0 is monitored in UE-specific search space and if the number of information bits in the DCI format 0_0 prior to padding is less than the payload size of the DCI format 1_0 monitored in UE-specific search space for scheduling the same serving cell, a number of padding bits (e.g., zero padding bits) may be generated for the DCI format 0_0 until the payload size equals that of the DCI format 1_0. If DCI format 1_0 is monitored in UE-specific search space and if the number of information bits in the DCI format 1_0 prior to padding is less than the payload size of the DCI format 0_0 monitored in UE-specific search space for scheduling the same serving cell, padding bits (e.g., zeros) may be appended to the DCI format 1_0 until the payload size equals that of the DCI format 0_0.

Step 2: Determine DCI format 0_1 monitored in a UE-specific search space. Determine DCI format 1_1 monitored in a UE-specific search space. For a UE configured with supplementaryUplink in ServingCellConfig in a cell, if PUSCH is configured to be transmitted on both the SUL and the non-SUL of the cell and if the number of information bits in format 0_1 for the SUL is not equal to the number of information bits in format 0_1 for the non-SUL, padding bits (e.g., zeros) may be appended to smaller format 0_1 until the payload size equals that of the larger format 0_1. If the size of DCI format 0 1 monitored in a UE-specific search space equals that of a DCI format 0_0/1_0 monitored in another UE-specific search space, one bit of padding (e.g., zero padding) may be appended to DCI format 0_1. If the size of DCI format 1_1 monitored in a UE-specific search space equals that of a DCI format 0_0/1_0 monitored in another UE-specific search space, one bit of padding (e.g., zero padding) may be appended to DCI format 1_1.

Step 2A: Determine DCI format 0_2 monitored in a UE-specific search space. Determine DCI format 1_2 monitored in a UE-specific search space. For a UE configured with supplementaryUplink in ServingCellConfig in a cell, if PUSCH is configured to be transmitted on both the SUL and the non-SUL of the cell and if the number of information bits in format 0_2 for the SUL is not equal to the number of information bits in format 0_2 for the non-SUL, padding bits (e.g., zeros) may be appended to smaller format 0_2 until the payload size equals that of the larger format 0_2.

Step 3: If both of the following conditions are fulfilled the size alignment procedure may be complete: the total number of different DCI sizes configured to monitor is no more than 4 for the cell; the total number of different DCI sizes with C-RNTI configured to monitor is no more than 3 for the cell. Step 4: Otherwise, Step 4A: Remove the padding bit (if any) introduced in step 2 above. Determine DCI format 1_0 monitored in a UE-specific search space. Determine DCI format 0_0 monitored in a UE-specific search space. If the number of information bits in the DCI format 0_0 monitored in a UE-specific search space prior to padding is less than the payload size of the DCI format 1_0 monitored in UE-specific search space for scheduling the same serving cell, a number of zero padding bits may be generated for the DCI format 0_0 monitored in a UE-specific search space until the payload size equals that of the DCI format 1_0 monitored in a UE-specific search space. If the number of information bits in the DCI format 0_0 monitored in a UE-specific search space prior to truncation is larger than the payload size of the DCI format 1_0 monitored in UE-specific search space for scheduling the same serving cell, the bitwidth of the frequency domain resource assignment field in the DCI format 0_0 may be reduced by truncating the first few most significant bits such that the size of DCI format 0_0 monitored in a UE-specific search space equals the size of the DCI format 1_0 monitored in a UE-specific search space. Step 4B: If the total number of different DCI sizes configured to monitor is more than 4 for the cell after applying the above steps, or if the total number of different DCI sizes with C-RNTI configured to monitor is more than 3 for the cell after applying the above steps: If the number of information bits in the DCI format 0_2 prior to padding is less than the payload size of the DCI format 1_2 for scheduling the same serving cell, a number of padding bits (e.g., zero padding bits) may be generated for the DCI format 0_2 until the payload size equals that of the DCI format 1_2. If the number of information bits in the DCI format 1_2 prior to padding is less than the payload size of the DCI format 0_2 for scheduling the same serving cell, padding bits (e.g., zeros) may be appended to the DCI format 1_2 until the payload size equals that of the DCI format 0_2. Step 4C: If the total number of different DCI sizes configured to monitor is more than 4 for the cell after applying the above steps, or if the total number of different DCI sizes with C-RNTI configured to monitor is more than 3 for the cell after applying the above steps: If the number of information bits in the DCI format 0_1 prior to padding is less than the payload size of the DCI format 1_1 for scheduling the same serving cell, a number of padding bits (e.g., zero padding bits) may be generated for the DCI format 0_1 until the payload size equals that of the DCI format 1 1. If the number of information bits in the DCI format 1 1 prior to padding is less than the payload size of the DCI format 0_1 for scheduling the same serving cell, padding bits (e.g., zeros) may be appended to the DCI format 1 1 until the payload size equals that of the DCI format 0 1.

In existing downlink control information (DCI) encoding solutions, zero padding may be used to append zero padding bits to a sequence of DCI bits. The zero-padding may be performed in response to a DCI size alignment process. For example, the DCI size may be aligned with a reference DCI size based on the DCI size alignment process. In existing zero padding solutions, O-bits may be added to a data stream (e.g., a sequence of data bits such as DCI bits). For example, a size alignment process (e.g., DCI size alignment process) may determine a target number of padding bits that are required (e.g., a first number of padding bits). Thereafter, the size alignment process can generate zero padding bits to the DCI format 0_0 until the payload size equals that of the DCI format 1_0 (e.g., the target number of padding bits). For example, a size alignment process (e.g., DCI size alignment process) may determine a first number of padding bits to correspond to a target number of padding bits, and the first number of zero padding bits may be generated to append to the smaller DCI format 0_0 until the payload size equals that of the larger DCI format 0_0.

In some examples, to adjust the required/transmission bandwidth of a sequence of bits to the available bandwidth, adding padding bits or puncturing of the sequence of bits may be used. In the case of puncturing, not every bit of an encoded data stream may be transmitted to the receiver and one or more bits may be punctured from the sequence of bits. During the decoding process, the receiver may include/insert bits (e.g., random bits) into the raw data stream. The insertion/addition of the random bits may decrease the signal to noise ration and/or increase the error rate of the raw data stream. At the receiver side and using the error correcting capability, the decoding process may decode the encoded data correctly. The puncturing process and including the random bits at the receiver may result in reducing the signal to noise ratio of the raw data and may increase the error rate.

In some examples, adding the padding bits, based on a padding process, may be used when the required/transmission bandwidth is lower than the available bandwidth. The padding process may increase the transmission bandwidth to the available bandwidth. Some bits or symbols may be added to the data stream. The bits or symbols may not include useful information. The padding process may not contribute to the signal to noise ratio as no meaningful information may be transmitted by the padding bits. The addition of the padding bits, using the padding process, may not increase the signal to noise ratio. The padding bits may not reduce the error rate or may not increase the signal to noise ratio and may not enhance the overall system performance.

Example embodiments enable more efficient utilization of the available bandwidth by utilizing padding bits in a meaningful manner, e.g., to increase the signal level or enhance the signal to noise ratio and/or to decrease the error rate. Example embodiments may enhance the system performance and may enable reducing the required transmission power levels and improving the overall system capacity.

In some examples, a system can first determine that additional bits may be appended to a sequence of data bits. For example, the system can determine that additional bits may be appended for purposes of a size alignment, such as a DCI-based size alignment. The system can then use additional bits to send redundant data and the overall signal or signal to noise ratio may be improved. In some examples, polar encoding may be used, and a polar encoder may generate encoded data with a length that is a power of 2 (e.g., 4, 16, . . . ). Other encoding mechanisms may also be used such as convolutional encoders, etc.

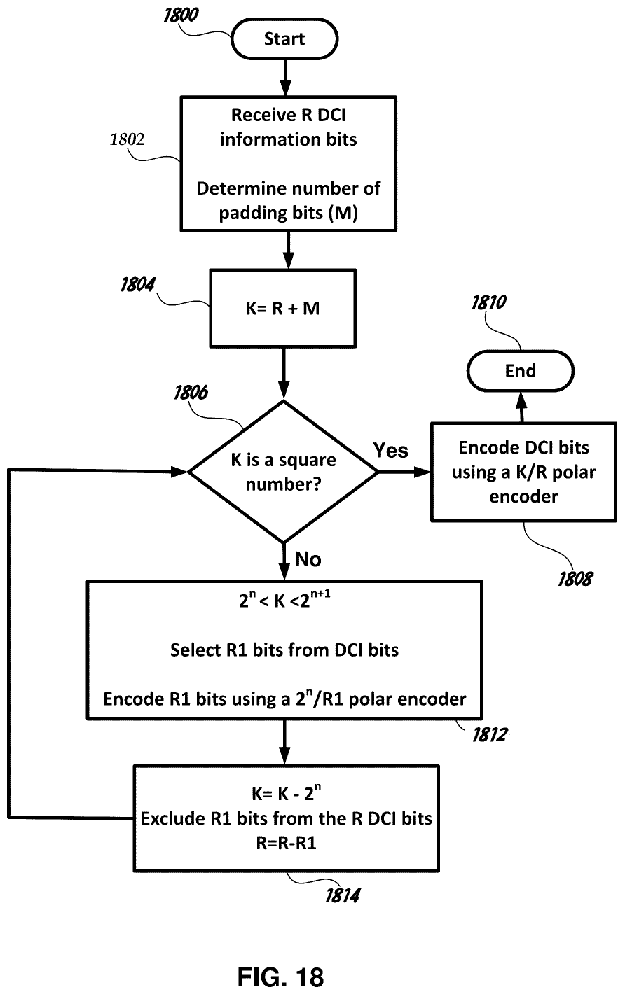

In some examples, an encoding mechanism as shown in FIG. 18 may be used. At block 1802, the encoding mechanism (e.g., a polar encoding mechanism) may accept, as input, a sequence of R bits and may encode the sequence of R bits using a R/(R+M) coding process, resulting in R+M encoded bits, when M padding bits are required. In some examples, multiple such encoders may be combined to allow for any number of padding bits being encoded by selecting an appropriate combination of the encoding processes. An appropriate set of encoding processes may be used to generate the M padding bits. The encoding mechanism of FIG. 18 may enable encoding a message with R bits into a message with K=(R+M) bits. In an example, R information bits (e.g., DCI information bits) may be received, and the number of padding bits (M) may be determined (e.g., based on a size alignment process).

At block 1804, a calculation of K=R+M is determined. A decision block 1806, a determination of whether K=R+M is a square number is conducted. If K=R+M is a square number (e.g., power of two of an integer), a polar encoder with rate K/R may be selected at block 1808. In some examples, other encoders such as convolutional encoders may be used. Alternatively, K is not a square number and if 2ⁿ<K<2ⁿ⁺¹, at block 18012, R1 bits of the R bits may be selected and a polar encoder of rate 2ⁿ/R1 may be applied to the R1 bits to encode R1 bits resulting in 2ⁿ encoded bits. At block 1814, the system sets K=K−2ⁿ and R=R−R1 and excludes the R1 bits from the DCI bits The above process may be repeated. For example, for K=20, a first polar encoder may generate 16 encoded bits by encoding a first subset of DCI bits and a second polar encoder may generate 4 encoded bits by encoding a second subset of the DCI bits. The union of the first subset and the second subset may be all of the DCI bits and the intersection of the first subset and the second subset may be empty.

The encoding mechanism with example shown in FIG. 18, may incorporate the otherwise unused bits and may improve the overall signal and/or signal to noise ratio by a polar encoding process. The polar encoding process may be designed to generate the output as a power of two. One or more multiple polar encoding processes may be combined such that any number of encoded bits may be generated. The padding bits may be used to increase the signal to noise ratio. Using the polar encoding process, several encoders may be combined to produce any (even) number of encoded bits. The overall system capacity may be improved and the signal to noise ratio may be increased.

In some examples, repetition of bits may increase the redundancy and the signal level and/or the signal to noise ratio may be improved. A coherent combination on the receiver side may increase the signal level and/or SNR. Backward compatibility may be preserved with receivers, which may not implement the redundancy and may ignore the padding bits.

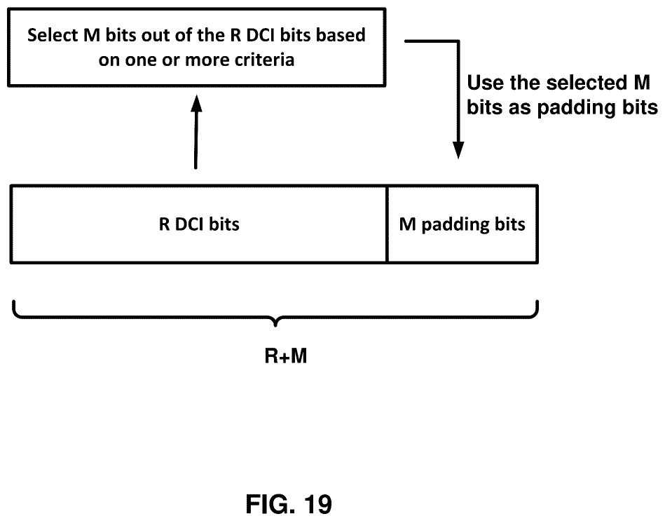

In some examples, certain important bits or symbols, for example reference signals, may be repeated and used for padding. An example is shown in FIG. 19. Assuming that there are R message bits and a padding process may determine M padding bits to match the bandwidth (e.g., based on a size alignment process such as DCI size alignment), K may be set as K=R+M (e.g., sum of message bits and padding bits). Out of the R bits, M bits (e.g., depending on the importance of bits such as M most important bits) may be selected an appended to the R bits. Using the mechanism of FIG. 19, a subset of the message, such as some important parts of the message, may be transmitted twice. On the receiver side the M bits which are transmitted twice may be combined coherently. The padding bits may be used to increase the signal to noise ratio and/or decrease the error rate. Since bits may be simply repeated the system may be backward compatible with the existing solution on the receiver side. The overall system capacity may be increased and the signal to noise ratio may be increased. No zero padding may be necessary, which means the entire bandwidth may be used for useful signal. The receiver may ignore the padding bits and backward compatibility may be achieved.

In some examples, convolutional encoding processes may add redundancy by encoding the message and translate the message into a larger message. Encoders may come in different implementations and may provide for example an increase of the message by 100%, 50% or for example 33% (e.g., coding rates 1/2, 2/3, 3/4, etc.).

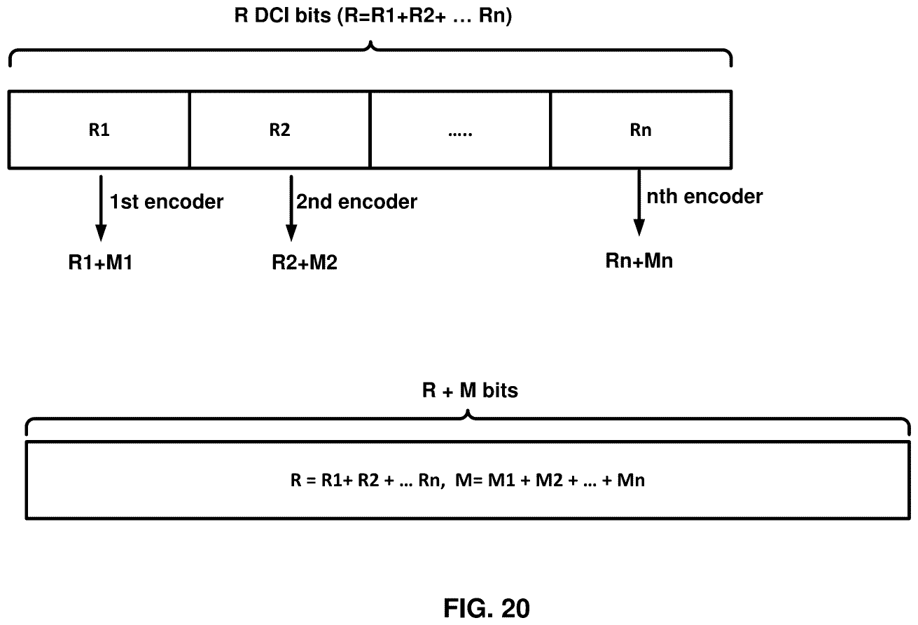

In some examples, encoders may be selected with the appropriate rates and may be combined to encode different numbers of padding bits. An example is shown in FIG. 20. For example, if a message size is R bits and M padding bits are required, the signal may be improved by applying one or several convolutional encoders so that a combined R/(R+M) encoder is realized. One or multiple encoding processes may be combined. A plurality of encoders and a plurality of subsets of input bits may be determined wherein each of the plurality of encoders may be applied to a corresponding subset of input bits. In some examples, the plurality of encoders may be selected from a set of pre-determined encoding processes. The set of pre-determined encoders may be 1/2, 2/3, 3/4 encoders, etc. For example, a message size may be R bits and M additional padding bits may be need based on a padding process (for example, to achieve size alignment based on a size alignment process such as DCI size alignment). The R bits may be divided in a plurality of subsets (e.g., first subset with R1 bits, . . . , nth subset with Rn bits) and the i-th subset may be encoded with a corresponding encoder with rate (Ri+Mi)/Ri resulting in Ri+Mi encoded bits. The total size of encoded bits is therefore (R1+ . . . +Rn+M1+ . . . +Mn), where R=R1+ . . . +Rn and M=M1+=Mn.

By using the process in FIG. 20, padding bits may be utilized to improve the signal to noise ratio; bits may be encoded with convolutions encoders to generate the padding bits; different encoders may be combined to generate the appropriate number of bits; no zero padding may be necessary, the entire bandwidth may be used for useful signal; and the overall system capacity may be increased because the signal to noise ratio is increased.

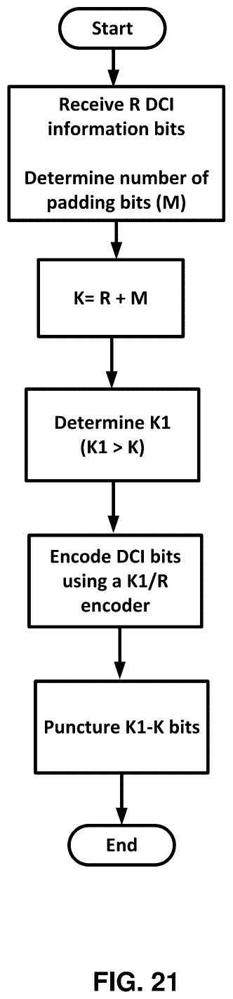

In some examples as shown in FIG. 21, the R message bits (e.g., DCI bits) may be received and the number of the padding bits (M) may be determined, for example based on size alignment process (e.g., DCI size alignment). The total number of required bits may be K=R+M and an integer K1 (K1>K) may be determined. For example, K1 may be the smallest square number that is larger than K. In some examples, other criteria for selecting K1 may be used. A coding process with a high redundancy (e.g., with a coding rate K1/R) may be used to achieve K1 encoded bits. A puncturing process may be used to adjust the number of bits (e.g., to puncture K1−K bits out of the K1 encoded bits). The additional redundant bits of the high-rate encoder may meet or exceed the number of otherwise unused or padded bits.

By using a high coding rate, high signal to noise ratio may be achieved and the encoder may be robust against errors, for example if the errors are equally distributed. By using a high coding rate, enough encoded bits may be available such that a puncturing process results in the total number of required bits (e.g., R+M bits). The upfront increase in redundancy improves the signal above and beyond the reduction which may be imposed by the puncturing process. The example embodiment in FIG. 21 may increase the number of redundant bits so that all available bits may be actually used, and the SNR may be increased. Through a puncturing process the number of bits is reduced only so far that the final bandwidth is achieved and a net increase in SNR may be achieved. The example process in FIG. 21 may utilize existing encoding processes for the high-rate encoder and existing puncturing processes may be used.

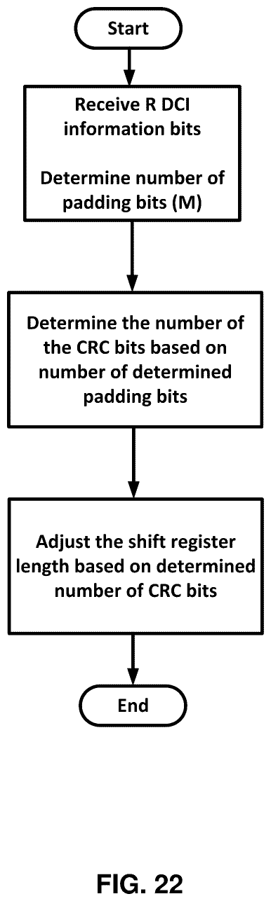

In some examples, a cyclic redundancy check (CRC) mechanism may be used. The CRC mechanism may use a polynomial and shift register. The size of the CRC may be selected/adapted by using the output of the shift register as needed. In some examples, additional CRC bits may be transmitted instead of padding bits. This process may improve the error detection capability by using additional CRC bits instead of padding bits. An example process is shown in FIG. 22. A CRC accumulator may be defined or extended to a desirable length. The additional bits may be used to improve the error detection capabilities of the system by increasing the number of CRC bits. The CRC bits may be generated by using a CRC polynomial and an XOR function, which may apply new data to the CRC bits in combination with a shift register. The length of the said shift register may not have a fixed size and may be adapted. In some examples, a large CRC may be used, and a subset of CRC bits may be used corresponding to the number of available padding bits. By sending additional CRC bits, the detection rate may be improved. For example, errors, which may accidentally stay undetected have a greater chance of being detected.

In some examples, the number of CRC bits which may be transmitted may be flexible. In some example, different CRC processes may be used which may provide a large number of CRC bits in the first place, and a subset corresponding to the number of available bits may be transmitted. Example process in FIG. 22, may improve error detection.

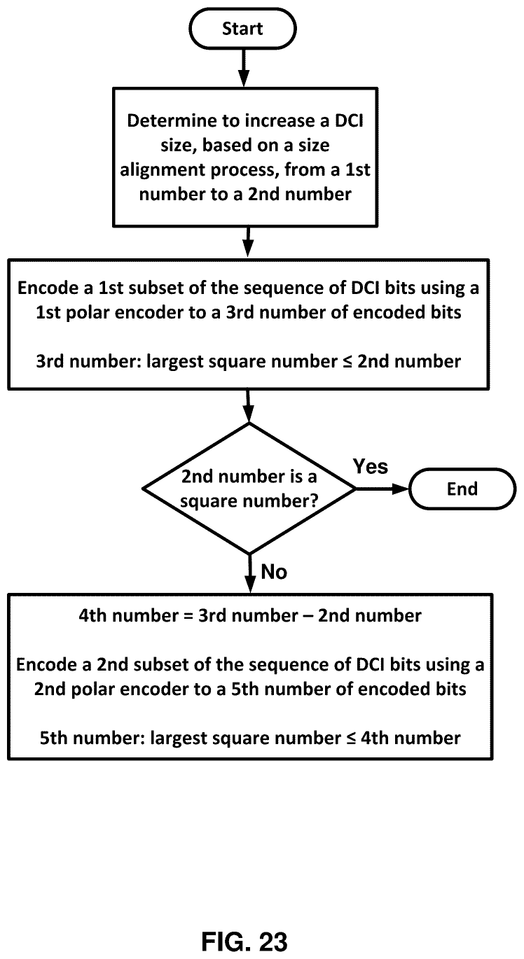

In an example embodiment as shown in FIG. 23, a network entity (e.g., a base station or a UE) may encode a sequence of bits for transmission over a communications link. For example, the sequence of bits may be a sequence of downlink control information (DCI) bit. The network entity may determine (e.g., based on a DCI size alignment process) to adjust/align the size of the sequence of DCI bits. For example, the network entity may determine to increase a size of the sequence of DCI bits from a first number to a second number. The increase in the size of the DCI bits may be based on a DCI size alignment process. The network entity may determine a first subset of the sequence of DCI

bits and may encode the first subset of the sequence of DCI bits using a first encoding mechanism (e.g., a first polar encoder). The first encoder may generate a third number of encoded bits from the first subset of the sequence of DCI bits. The first encoder may generate encoded bits with a number that is a power of 2. The third number may be the largest square number (e.g., power of two) that is smaller than the second number. If the second number is a square number, the third number may be equal to the second number and the first subset of the sequence of DCI bits may be the same as the sequence of DCI bits and the encoding process may stop. If the second number is not a square number (e.g., if the second number is larger than 2n and smaller than 2n+1 for some n), the network entity may first determine a fourth number as the difference between the second number and the third number. For example, if the second number is 20, the third number may be 16 and the fourth number may be 4.

The network entity may determine a second subset of the sequence of DCI bits and may encode the second subset of the sequence of DCI bits. The network entity may exclude the first subset of the sequence of DCI bits and may determine the second subset of the sequence of DCI bits after excluding the first subset from the sequence of DCI bits. The network may encode the second subset of the sequence of DCI bits and may generate a fifth number of encoded bits. The fifth number may be the largest square number that is smaller than the fourth number. If the fourth number is a square number (e.g. if the fourth number equals the fifth number), the encoding process may stop. If the fourth number is not a square number, the process may continue.

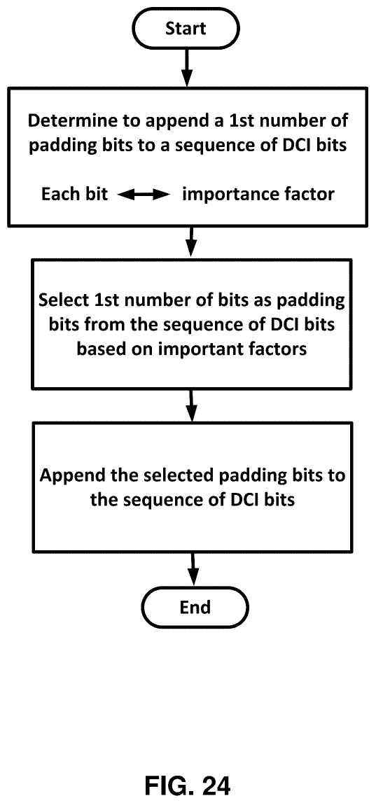

In an example embodiment as shown in FIG. 24, a network entity (e.g., a base station or a UE) may encode a sequence of bits for transmission over a communications link. For example, the sequence of bits may be a sequence of downlink control information (DCI) bit. The network entity may determine (e.g., based on a DCI size alignment process) to adjust/align the size of the sequence of DCI bits. For example, the network entity may determine to append a first number of padding bits to the sequence DCI bits. Individual bits (e.g., each bit) in the sequence of DCI bits may be associated with an importance factor. For example, the importance factor associated with a bit may be based on a field of the DCI that the bit is included. Some fields may be more important than the other bits or otherwise be associated with a higher priority relative to other bits. The network entity may select the first number of bits (e.g., as many as the additional bits to be appended) as the padding bits from the sequence of DCI bits. The network entity may select the first number of bits from the sequence of DCI bits based at least in part on the importance factors (or importance information) of the bits in the sequence of DCI bits. For example, the network entity may select the first number of most important bits from the sequence of DCI bits. The network entity may append the selected padding bits to the sequence of DCI bits.

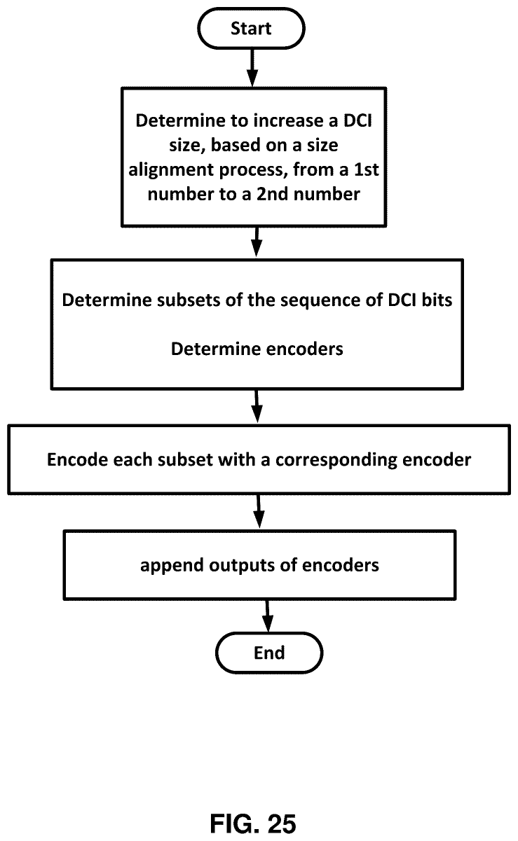

In an example embodiment as shown in FIG. 25, a network entity (e.g., a base station or a UE) may encode a sequence of bits for transmission over a communications link. For example, the sequence of bits may be a sequence of downlink control information (DCI) bit. The network entity may determine (e.g., based on a DCI size alignment process) to adjust/align the size of the sequence of DCI bits. For example, the network entity may determine to increase a size of the sequence of DCI bits from a first number to a second number. The increase in the size of the DCI bits may be based on a DCI size alignment process. The network entity may determine a plurality of subsets of the sequence of DCI bits. For example, a union of the plurality of subsets may be the sequence of the DCI bits and any two subsets of the plurality of subsets may have an empty intersection.

The network entity may determine a plurality of encoders for the plurality of subsets of the sequence of DCI bits. In an example, the plurality of encoders may comprise convolutional encoders. In an example, the plurality of encoders may comprise polar encoders. Other encoder types may be used in some examples. Each encoder in the plurality of encoders may be associated with and may be used for encoding a corresponding subset of the sequence of DCI bits, in the plurality of subsets of the sequence of DCI bits. The network entity may encode each subset of the sequence of DCI bits, of the plurality of subsets of the sequence of DCI bits, with a corresponding encoder in the plurality of encoders. For example, if subset i of the sequence of DCI bits include Ri bits and is encoded with an encoder with rate (Ri+Mi)/Ri, the result is Ri+Mi encoded bits. The outputs of the plurality of encoders may be appended such that the combined size of the outputs of the plurality of encoders is the second number (e.g., the second number determined by the size alignment process). The combined coding rate may be the second number over the first number. For example, the first number may be R1+ . . . +Rn and the second number may be R1+ . . . +Rn+M1+ . . . +Mn.

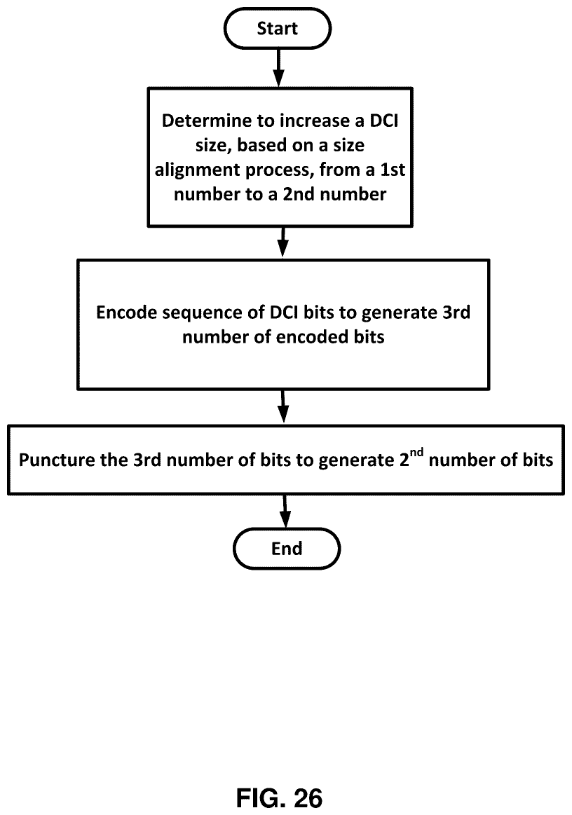

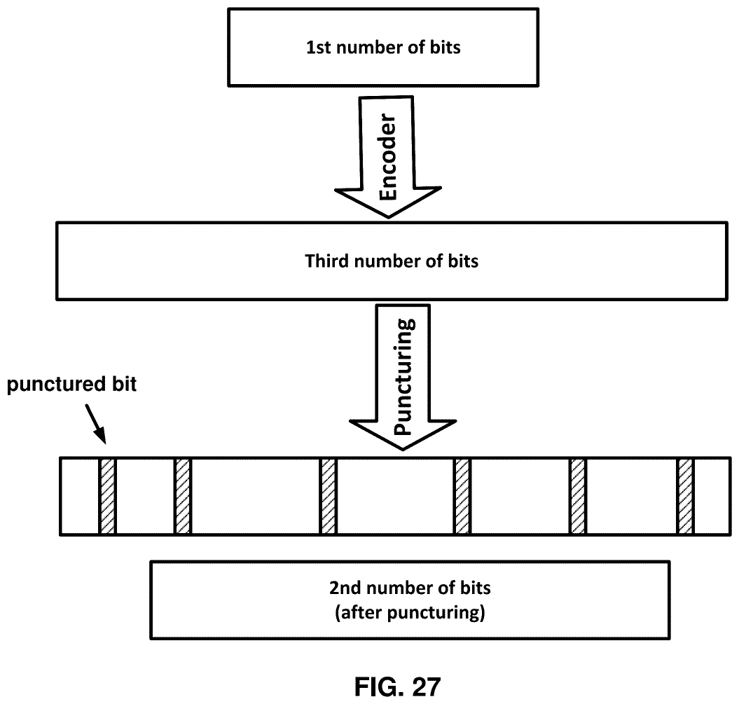

In an example embodiment as shown in FIG. 26 and FIG. 27, a network entity (e.g., a base station or a UE) may encode a sequence of bits for transmission over a communications link. For example, the sequence of bits may be a sequence of downlink control information (DCI) bit. The network entity may determine (e.g., based on a DCI size alignment process) to adjust/align the size of the sequence of DCI bits. For example, the network entity may determine to increase a size of the sequence of DCI bits from a first number to a second number. The increase in the size of the DCI bits may be based on a DCI size alignment process. The network entity may determine a third number, larger than equal with the second number, and may encode the sequence of DCI bits with an encoder that generates third number of bits. The network entity may determine the third number based on one or more criteria. For example, the network entity may determine the third number as the smallest square number that is larger than the second number. The third number may be larger than the second number and the difference between the third number and the second number may be a fourth number.

The network entity may encode, using an encoder (e.g., a polar encoder, a convolutional encoder, etc.) the sequence of bits (e.g., the sequence of DCI bits) and generate a third number of encoded bits. The third number of bits may have a size larger than the size determined by the DCI size alignment process. The network entity may puncture the third number of bits from the output of the encoder as shown in FIG. 27. The puncturing process may comprise removing one or more bits from the sequence of encoded bits. The number of encoded bits after puncturing may be the second number (e.g., the number determined by the size alignment process).

In the example embodiments, a size alignment process may comprise comparing the size of the sequence of DCI bits with a reference DCI size (e.g., a size of a second DCI size) and may comprise padding or puncturing the DCI bits to achieve a desirable size. The DCI may have a format according to one of a pre-defined number of formats and may be used for transmission of control information and for a variety of purposes (e.g., uplink or downlink scheduling, etc.). The DCI may be used for transmission of UE-specific control information or common control information used by a variety of UEs.

In an embodiment, a polar encoding process may be used. A network entity may determine to increase a size of a sequence of downlink control information (DCI) bits from a first number to a second number. The network entity may encode a first subset of the sequence of DCI bits using a first polar encoder, wherein the first polar encoder may generate a third number of encoded bits, and wherein the third number may be a largest square number that is smaller than or equal to the second number. If the second number is not a square number: the network entity may determine a fourth number as a difference between the second number and the third number. The network entity may encode a second subset of the sequence of DCI bits, using a second polar encoder, wherein the second polar encoder may generate a fifth number of encoded bits, and wherein the fifth number may be a largest square number that is smaller than or equal to the fourth number.

In some embodiments, the second number may be a square number. The first subset of the sequence of DCI bits may include all the DCI bits. The third number may be equal to the second number.

In some embodiments, the second subset of the sequence of DCI bits may be the sequence of the DCI bits excluding the first subset of the sequence of DCI bits. In some embodiments, the fourth number may be a square number; and the fifth number may be equal to the fourth number.

In some embodiments, a first size of the first subset of the sequence of DCI bits may be based on a first coding rate of the first polar encoder and the third number; and a second size of the second subset of the sequence of DCI bits may be based on a second coding rate of the second polar encoder and the fifth number.

In an embodiment, a network entity may determine, based on a size alignment process, to append a first number of padding bits to a sequence of downlink control information (DCI) bits, wherein each bit, in the sequence of DCI bits, may be associated with an importance factor. The network entity may select from the sequence of DCI bits and based on the importance factors of the bits in the sequence of DCI bits, the first number of bits as the padding bits. The network entity may append the selected padding bits to the sequence of DCI bits.

In some embodiments, the importance factor of a bit, in the sequence of DCI bits, may be based on a field of the DCI that the bit is associated with. In some embodiments, the selecting the first number of bits, from the sequence of DCI bits, may comprise selecting the first number of bits associated with one or more highest importance factors.

In an embodiment, a network entity may determine, based on a size alignment process, to increase a size of a sequence of downlink control information (DCI) bits from a first number to a second number. The network entity may determine a plurality of subsets of the sequence of DCI bits and a plurality of encoders, wherein each encoder, in the plurality of encoders, may be associated with a subset of the sequence of DCI bits in the plurality of subsets of the sequence of DCI bits. The network entity may encode each subset of the sequence of DCI bits, of the plurality of subsets of the sequence of DCI bits, with a corresponding encoder in the plurality of encoders. The network entity may append outputs of the plurality of encoders, wherein: a combined size of the outputs of the plurality of encoders may be the second number; and a combined coding rate of the plurality of encoders may be the second number over the first number.

In some embodiments, a union of the plurality of subsets of the sequence of DCI bits may be the sequence of DCI bits.

In some embodiments, at least some of the plurality of encoders may be convolutional encoders.

In an embodiment, a network entity may determine, based on a size alignment process, to increase a size of a sequence of downlink control information (DCI) bits from a first number to a second number. The network entity may encode, using an encoder, the sequence of DCI bits to generate a third number of encoded bits. The network entity may puncture, using a puncturing process, the third number of encoded bits to generate the second number of bits.

In some embodiments, the puncturing process may comprise removing one or more bits from the third number of encoded bits.

In some embodiments, the third number may be the smallest square number that is larger than the second number.

In some embodiments, the encoder may be a polar encoder.

In some embodiments, the size alignment process may comprise comparing the size of the sequence of downlink control information (DCI) bits with a reference size.

In some embodiments, the reference size may be associated with a second sequence of downlink control information (DCI) bits.

In some embodiments, the downlink control information (DCI) may be associated with one of a plurality of pre-defined formats. In some embodiments, the plurality of pre-defined formats may be for transmission of one of a user equipment (UE)-specific control information or a common control information.

In some embodiments, a format of the downlink control information (DCI) is associated with one of downlink scheduling or uplink scheduling.

The exemplary blocks and modules described in this disclosure with respect to the various example embodiments may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. Examples of the general-purpose processor include but are not limited to a microprocessor, any conventional processor, a controller, a microcontroller, or a state machine. In some examples, a processor may be implemented using a combination of devices (e.g., a combination of a DSP and a microprocessor, multiple microprocessors, one or more microprocessors in conjunction with a DSP core, or any other such configuration).

The functions described in this disclosure may be implemented in hardware, software executed by a processor, firmware, or any combination thereof. Instructions or code may be stored or transmitted on a computer-readable medium for implementation of the functions. Other examples for implementation of the functions disclosed herein are also within the scope of this disclosure. Implementation of the functions may be via physically co-located or distributed elements (e.g., at various positions), including being distributed such that portions of functions are implemented at different physical locations.

Computer-readable media includes but is not limited to non-transitory computer storage media. A non-transitory storage medium may be accessed by a general purpose or special purpose computer. Examples of non-transitory storage media include, but are not limited to, random access memory (RAM), read-only memory (ROM), electrically erasable programmable ROM (EEPROM), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable media.

As used in this disclosure, use of the term “or” in a list of items indicates an inclusive list. The list of items may be prefaced by a phrase such as “at least one of” or “one or more of”. For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise”, “include” or “contain” may be used interchangeably and have the same meaning and are to be construed as inclusive and open-ending. The terms “comprise”, “include” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

1. A method of polar encoding, comprising:
determining, based on a size alignment process, whether to increase a size of a sequence of downlink control information (DCI) bits from a first number to a second number; and
if in response to a determination that the size of the sequence of DCI bits is to be increased, encoding a first subset of the sequence of DCI bits using a first polar encoder,
wherein, the first polar encoder generates a third number of encoded bits,_ and the third number is a largest number that is a power of two and smaller than or equal to the second number.

2. The method of claim 1, wherein:
the second number is a number that is a power of two;
the first subset of the sequence of DCI bits includes all the DCI bits; and
the third number is equal to the second number.

3. The method of claim 1, wherein a second subset of the sequence of DCI bits is a sequence of the DCI bits excluding the first subset of the sequence of DCI bits.

4. The method of claim 3, wherein the method further comprises:
determining a fourth number that is a power of two; and
encoding the second subset of the sequence of DCI bits using a second polar encoder, wherein the second polar encoder generates a fifth number of encoded bits, and the fifth number is equal to the fourth number.

5. The method of claim 4, wherein:
a first size of the first subset of the sequence of DCI bits is based on a first coding rate of the first polar encoder and the third number; and
a second size of the second subset of the sequence of DCI bits is based on a second coding rate of the second polar encoder and the fifth number.

6. The method of any of claim 1, wherein the DCI is associated with one of a plurality of pre-defined formats.

7. A method of generating padding bits for coding, comprising:
determining whether to append one or more padding bits to a sequence of downlink control information (DCI) bits, wherein individual bits in the sequence of DCI bits are associated with importance factors;
responsive to a determination that the one or more padding bits are to be appended, selecting, from the sequence of DCI bits, a number of bits as the one or more padding bits based at least in part on the importance factors of the individual bits in the sequence of DCI bits; and
appending the selected one or more padding bits to the sequence of DCI bits.

8. The method of claim 9, wherein an importance factor of a bit in the sequence of DCI bits is based on a field of a DCI that the bit is associated with.

9. The method of claim 7, wherein the selecting the number of bits, from the sequence of DCI bits, further includes selecting a number of bits associated with one or more highest importance factors.

10. The method of claim 7, wherein a format of the DCI is associated with one of downlink scheduling or uplink scheduling.

11. A method of coding, comprising:
determining, based on a size alignment process, whether a number of bits in a sequence of downlink control information (DCI) bits is less than a target number of bits;
in response to a determination that the number of bits in the sequence of DCI bits is less than the target number of bits, encoding each of a plurality of subsets of the sequence of DCI bits with a corresponding encoder of one or more encoders; and
appending outputs of the one or more encoders to form an output sequence, wherein a size of the output sequence corresponds to the target number of bits, and wherein at least one coding rate of the one or more encoders corresponds to a quotient of the target number of bits and the number of bits in the sequence of DCI bits.

12. The method of claim 11, wherein a union of the plurality of subsets of the sequence of DCI bits is the sequence of DCI bits.

13. The method of claim 11, wherein one or more of the one or more encoders are convolutional encoders.

14. The method of claim 11, wherein one or more of the one or more encoders are polar encoders.

15. A method of coding, comprising
determining, based on a size alignment process, whether to increase a size of a sequence of downlink control information (DCI) bits from a first number to a second number;
in response to a determination that the size of the sequence of DCI bits is to be increased, encoding, using an encoder, the sequence of DCI bits to generate a third number of encoded bits; and
puncturing, using a puncturing process, the third number of encoded bits to generate the second number of bits,
wherein the third number is a smallest number that is a power of two and larger than the second number.

16. The method of claim 15, wherein the puncturing process comprises removing one or more bits from the third number of encoded bits.

17. (canceled)

18. The method of claim 15, wherein the encoder is a polar encoder.

19. The method of claim 15, wherein the size alignment process comprises comparing the size of the sequence of DCI bits with a reference size.

20. The method of claim 19, wherein the reference size is associated with a second sequence of DCI bits.

21. The method of claim 15, wherein the DCI is associated with one of a plurality of pre-defined formats.

22. The method of claim 21, wherein each of the plurality of pre-defined formats is for transmission of one of user equipment (UE)-specific control information or common control information.

23. The method of claim 1, further comprising:
in response to a determination that the second number is not a number that is a power of two, determining a fourth number as a difference between the second number and the third number; and
encoding, a second subset of the sequence of DCI bits, using a second polar encoder, wherein the second polar encoder generates a fifth number of encoded bits, and wherein the fifth number is a largest number that is a power of two and smaller than or equal to the fourth number.
